(19) United States
(12) Patent Application Publication
(10) Pub. No.: US 2026/0089751 A1
(43) Pub. Date: Mar. 26, 2026

(54) TARGET WAKE TIME (TWT) SESSION ADAPTATION

(71) Applicant: QUALCOMM Incorporated, San Diego, CA (US)

(72) Inventors: Arpit BHATNAGAR, Bengaluru (IN); Rahul BHARTARI, Bangalore (IN); Abhishek RANKA, Bangalore (IN)

(21) Appl. No.: 18/898,576

(22) Filed: Sep. 26, 2024

(51) Int. Cl. H04W 74/04

(52) U.S. Cl. CPC H04W 74/04

(57) ABSTRACT

This disclosure provides methods, components, devices and systems for target wake time (TWT) session adaptation. Some aspects more specifically relate to TWT session establishment and adaptation that is based on data stream communication parameters and objective parameters associated with TWT operation. In some examples, a wireless communication device may determine a set of TWT sessions based on a respective set of communication parameters associated with each of multiple data streams such that a set of objective parameters associated with the set of TWT sessions satisfies one or more constraints of the wireless communication device. Additionally, or alternatively, the wireless communication device may manage the set of TWT sessions to reduce the losses associated with the set of TWT sessions or continue to satisfy the data stream communication parameters, or both, based on a channel switch, a change in a network condition, or a change in a user experience (UX) score.

### TECHNICAL FIELD

This disclosure relates generally to wireless communication and, more specifically, to target wake time (TWT) session adaptation.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication networks, one or more wireless communication devices may communicate in accordance with a target wake time (TWT) session, such as within or during one or more TWT service periods (SPs) associated with the TWT session. For example, a wireless communication device may communicate within one or more TWT SPs and may refrain from communicating outside of the one or more TWT SPs.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communication device. The wireless communication device may include a processing system that includes processor circuitry and memory circuitry that stores code. The processing system may be configured to cause the wireless communication device to obtain information indicative of a respective set of communication parameters associated with each data stream of a set of multiple data streams, where the set of multiple data streams is associated with an application at the wireless communication device, and perform wireless communication associated with the set of multiple data streams in accordance with a set of target wake time (TWT) sessions, where the set of TWT sessions is based on the respective set of communication parameters associated with each data stream of the set of multiple data streams, and where a set of objective parameters associated with the set of TWT sessions satisfies one or more constraints of the wireless communication device.

Another innovative aspect of the subject matter described in this disclosure can be implemented in a method for wireless communication by or at wireless communication device. The method may include obtaining information indicative of a respective set of communication parameters associated with each data stream of a set of multiple data streams, where the set of multiple data streams is associated with an application at the wireless communication device, and performing wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device.

Another innovative aspect of the subject matter described in this disclosure can be implemented in a wireless communication device. The wireless communication device may include means for obtaining information indicative of a respective set of communication parameters associated with each data stream of a set of multiple data streams, where the set of multiple data streams is associated with an application at the wireless communication device, and means for performing wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device.

Another innovative aspect of the subject matter described in this disclosure can be implemented in a non-transitory computer-readable medium storing code for wireless communication by a wireless communication device. The code may include instructions executable by one or more processors (such as or via a processing system) to obtain information indicative of a respective set of communication parameters associated with each data stream of a set of multiple data streams, where the set of multiple data streams is associated with an application at the wireless communication device, and perform wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device.

Some implementations of the method, wireless communication devices, and non-transitory computer-readable medium described herein may further include operations, features, means, or instructions for switching from performing the wireless communication associated with the set of multiple data streams via a first frequency channel to performing the wireless communication associated with the set of multiple data streams via a second frequency channel and updating the set of TWT sessions in association with switching from the first frequency channel to the second frequency channel.

Some implementations of the method, wireless communication devices, and non-transitory computer-readable medium described herein may further include operations, features, means, or instructions for obtaining information indicative of one or both of a roundtrip time or a streaming latency corresponding to the wireless communication associated with the set of multiple data streams and updating the set of TWT sessions in accordance with one or both of the roundtrip time or the streaming latency.

Some implementations of the method, wireless communication devices, and non-transitory computer-readable medium described herein may further include operations, features, means, or instructions for setting a state associated with a usage of the set of TWT sessions in accordance with a score pertaining to the wireless communication associated with the set of multiple data streams and performing additional wireless communication associated with the set of multiple data streams in accordance with the set of TWT sessions or without the set of TWT sessions in accordance with the state associated with the usage of the set of TWT sessions.

In some implementations of the method, wireless communication devices, and non-transitory computer-readable medium described herein, setting the state associated with the usage of the set of TWT sessions may include operations, features, means, or instructions for setting the set of TWT sessions to an OFF state in accordance with the score failing to satisfy a first threshold score and setting the set of TWT sessions to an ON state in accordance with the score satisfying a second threshold score.

Some implementations of the method, wireless communication devices, and non-transitory computer-readable medium described herein may further include operations, features, means, or instructions for assigning a respective independent TWT session for each data stream of the set of multiple data streams in accordance with the respective set of communication parameters associated with that data stream of the set of multiple data streams, where, for each data stream of the set of multiple data streams and based on the respective set of communication parameters associated with that data stream and the set of objective parameters, the method, wireless communication devices, and non-transitory computer-readable medium described herein may further include operations, features, means, or instructions for creating the respective independent TWT session for that data stream or merging the respective independent TWT session for that data stream with one or more other TWT sessions for one or more other data streams of the set of multiple data streams.

Details of one or more implementations of the subject matter described in this disclosure are set forth in the accompanying drawings and the description below.

Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example system diagram that supports target wake time (TWT) session adaptation.

FIG. 4 shows an example processing timeline that supports TWT session adaptation.

FIGS. 5 and 6 show example process flows that support TWT session adaptation.

FIG. 7 -10 show example TWT session determination schemes that supports TWT session adaptation.

FIG. 11 shows an example user experience (UX) scoring scheme that supports TWT session adaptation.

FIG. 12 shows a block diagram of an example wireless communication device that supports TWT session adaptation.

FIG. 13 -16 show flowcharts illustrating example processes performable by or at a wireless communication device that supports TWT session adaptation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, one or more wireless communication devices may support target wake time (TWT) operation according to which the wireless communication device(s) may “wake up” to perform wireless communications in accordance with a schedule of TWT service periods (SPs). Such wireless communications may include transmitting wireless signaling or receiving wireless signaling, or both, within the TWT SPs. Further, such a schedule of TWT SPs may be associated with a TWT session. For example, a TWT session may define a schedule of TWT SPs. A TWT SP may be equivalently referred to herein as a TWT window and may be associated with (defined by) one or more of a starting point, a duration, and an ending point. Additionally, a TWT session may be associated with, indicate, or define a frequency of TWT SPs, such that the TWT SPs of the TWT session occur at the frequency. In some networks, a wireless communication device may open a single TWT session at a time (such as a single TWT session per application at the wireless communication device or a single TWT session across a set of applications at the wireless communication device), such as for power savings or reduced complexity.

In some deployment scenarios, however, a wireless communication device may support an application associated with multiple different data streams, with different data streams potentially running at different cadences. For example, an application may be associated with a first data stream having a first frequency of data generation and a second data stream having a second frequency of data generation, with the second frequency potentially being different from the first frequency. Such an application may be an extended reality (XR), virtual reality (VR), augmented reality (AR), or mixed reality (MR) application and such scenarios may arise in various use cases, such as a use case involving split rendering/processing between a host device and a display device. In such deployment scenarios, a single TWT session may be unable to suitably serve the multiple data streams associated with the application. For example, a single TWT session may be associated with a single TWT SP frequency, which might be unable to satisfy latency tolerances of different data streams running at different cadences. Accordingly, some networks may allow multiple TWT sessions to be opened to satisfy the latency tolerances of the different data streams with, for example, each data stream being served by a respective TWT session. Such an approach, however, may result in high or otherwise unconstrained power consumption, which may be prohibitive for some device types. Thus, some networks and devices may benefit from additional configurational capabilities associated with TWT session establishment and adaptation to support various applications, such as applications associated with multiple data streams.

Various aspects relate generally to TWT session establishment and adaptation that is based on data stream communication parameters and objective parameters associated with TWT operation. Some aspects more specifically relate to a determination (such as an identification, a generation, a creation, a selection, or a configuration) of a set of TWT sessions based on a respective set of communication parameters associated with each of multiple data streams such that a set of objective parameters associated with the set of TWT sessions satisfies one or more constraints of a wireless communication device. To determine the set of TWT sessions, the wireless communication device may (initially or preliminarily) determine a respective independent TWT session for each data stream of the multiple data streams based on a respective set of communication parameters associated with that data stream. Based on determining an independent TWT session for each data stream of the multiple data streams, the wireless communication device may determine, for each data stream, whether to create (such as establish or open) the independent TWT session for that data stream or to merge the independent TWT session for that data stream with one or more other (already created or candidate) TWT sessions. The wireless communication device may determine whether to create an independent TWT session for a data stream or to merge the independent TWT session for the data stream with one or more other TWT sessions based on a set of communication parameters associated with the data stream and a set of objective parameters.

For example, if other (already created or candidate) TWT sessions are unable to satisfy a set of communication parameters associated with a data stream and if a set of objective parameters associated with (such as caused or incurred by) an independent TWT session for the data stream satisfies the device constraints, the wireless communication device may create the independent TWT session for the data stream.

Alternatively, if another TWT session can satisfy the set of communication parameters associated with the data stream or if the set of objective parameters associated with the independent TWT session for the data stream fails to satisfy the device constraints, the wireless communication device may merge the independent TWT session with another TWT session. The wireless communication device may manage (such as monitor and selectively adapt) the set of TWT sessions over time to reduce (such as to minimize) the set of objective parameters associated with the set of TWT sessions or to continue to satisfy the data stream communication parameters, or both, based on a channel switch, a change in a network condition, or a change in a user experience (UX) score, among other examples.

Particular aspects of the subject matter described in this disclosure can be implemented to realize one or more of the following potential advantages. In some examples, by establishing and adapting a set of TWT sessions based on data stream communication parameters and objective parameters associated with TWT operation, the described techniques can be used to achieve UX improvement and power reduction or to otherwise balance UX improvement with power reduction. For example, in scenarios in which a wireless communication device communicates multiple data streams concurrently (such that data of multiple data streams is communicated within a given period), the wireless communication device may implement one or more of the described TWT determination and adaptation schemes to reduce latencies associated with the multiple data streams. Such reduced latencies may offer a more seamless experience for an end user, such as by reducing a delay between an action (such as a user action or input) and a corresponding audio or visual experience provided to the end user or by reducing glitches experienced by the end user, or both. For instance, the example adaptive TWT schemes described herein may reduce frame repeats/misses and reduce an overall latency, which may result in a greater content quality and UX. For further example, the wireless communication device may implement one or more of the described TWT determination and adaptation schemes to dynamically turn TWT operation to an ON state or an OFF state, which may result in greater power efficiency at the wireless communication device. For example, in scenarios in which the wireless communication device experiences an overlapping basic service set (BSS) (OBSS) condition, the wireless communication device may enlarge TWT windows or enable multiple TWT windows, or both, to achieve power savings while maintaining performance (such as at least a threshold or target performance).

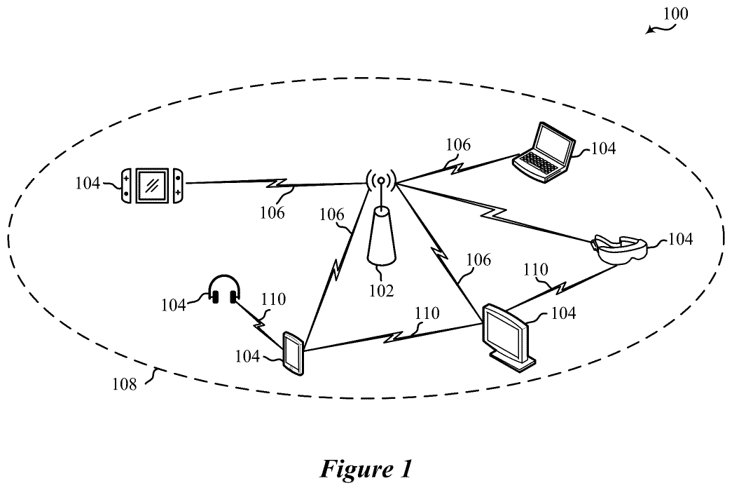

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, AR, VR, MR or XR wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), IoT devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz - 7.125 GHz), FR2 (24.25 GHz - 52.6 GHz), FR3 (7.125 GHz - 24.25 GHz), FR4 a or FR4 -1 (52.6 GHz - 71 GHz), FR4 (52.6 GHz - 114.25 GHz), and FR5 (114.25 GHz - 300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an OBSS transmission), the wireless communication device may switch to monitoring and contending on an O-Primary channel. In some examples, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

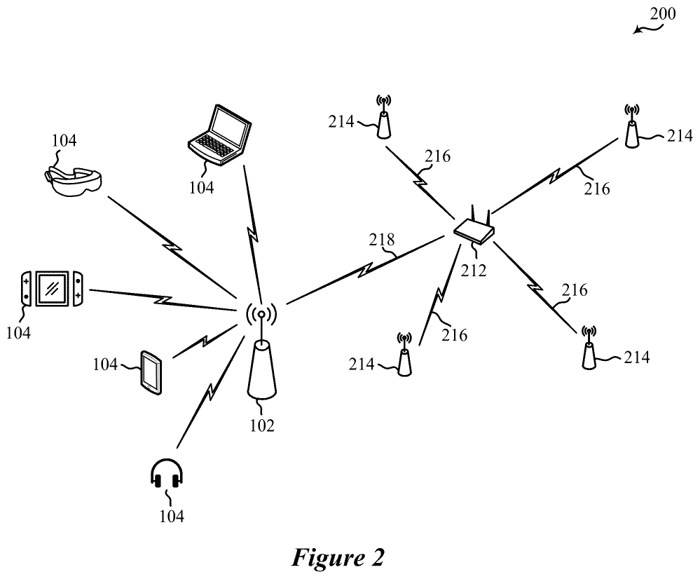

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

In accordance with some example implementations, various wireless communication devices of the wireless communication network 100 or the wireless communication network 200 may support TWT session adaptation, such as dynamic TWT session adaptation. Such TWT session adaptation may be based on one or more communication parameters associated with a set of data streams and, in some examples, a set of objective parameters associated with the resulting TWT session(s). For example, in accordance with some implementations disclosed herein, a wireless device may determine TWT sessions based on communication parameters associated with a set of data streams and such that a set of objective parameters associated with the TWT sessions satisfy one or more constraints or thresholds at the wireless device. As described herein, a wireless device may refer to any device capable of performing wireless communication (such as transmitting wireless signaling or receiving wireless signaling, or both). A wireless device (such as a wireless communication device) also may be capable of wired communication.

In some implementations, a wireless device may support an adaptive TWT scheme associated with split processing. In such an adaptive TWT scheme for split processing, if a network data stream (such as a network client) is not an integer multiple of another data stream (such as another client), the wireless device may request multiple TWT sessions, such as multiple TWT windows, from Wi-Fi. In some examples, the wireless device may determine whether to open, create, schedule, or generate one or more TWT sessions based on one or more factors, parameters, or constraints.

For example, in split processing scenarios in which pose data and frame data are the traffic on the network (such as the only traffic on the network), and if the pose data is associated with a transmission time or point that is relatively far from a transmission time or point of frame data, the wireless device may transmit the pose data and the frame data via multiple (such as separate) TWT sessions in a manner that considers power consumption and data latencies. For further example, if a data stream (such as a client) traffic has a frames-per-second (fps) that is more than a threshold amount lower as compared to another data stream (such as if three-dimensional (3D) recording (3DR) traffic is associated with 10 fps and render traffic is associated with 45 fps), the wireless device may reduce 3DR latency by opening a TWT session exclusively for 3DR traffic.

For further example, if a first data stream has an fps that is marginally different from (such as relatively similar to) an fps of a second data stream (such as if camera traffic is associated with 30 fps and render traffic is associated with 45 fps), the wireless device may create two parallel TWT sessions (such as a first TWT session for the first data stream and a second TWT session for the second data stream). The wireless device may run the two parallel TWT sessions exclusively or may overlap the two parallel TWT sessions, such that (at least sometimes) the wireless device may merge the two TWT sessions (with a merged TWT window being relatively larger to provide sufficient communication resources for both data streams, which may increase performance). In other words, over time, the two TWT sessions may run exclusively or may experience overlap, which may result in a single (common) larger TWT window. Some scenarios may be associated with combinations of various fps rates and transmission times and, accordingly, a wireless device may perform any combination of the techniques described herein to reduce data latency or increase power savings, or both.

The wireless device may perform determinations of whether to open multiple TWT sessions or to merge multiple (candidate) TWT sessions into a single TWT session by, using, or via one or more adaptive TWT components or modules of the wireless device. The one or more adaptive TWT components or modules may take or involve fps and latency tolerance, among other parameters, of different network transmitter clients (including one or both of uplink and downlink clients, such as one or both of uplink and downlink data streams) into account to support a TWT session determination that balances both performance and power.

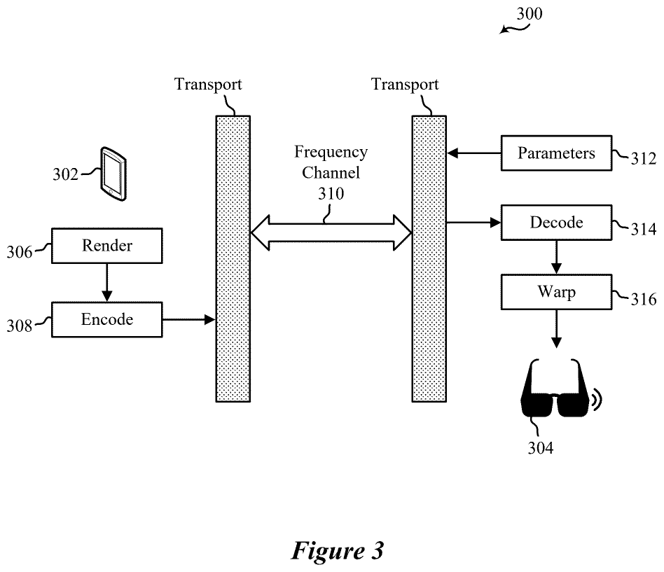

FIG. 3 shows an example system diagram 300 that supports TWT session adaptation. The system diagram 300 may implement or be implemented to realize one or more aspects of the wireless communication network 100 or the wireless communication network 200. For example, the system diagram 300 illustrates communication between a wireless device 302 and a wireless device 304, each of which may be an example of a wireless communication device as illustrated by or described with reference to FIG. 1 or FIG. 2. For example, the wireless device 302 may be an AP 102 or a STA 104, among other example wireless communication devices, and the wireless device 304 may be an AP 102 or a STA 104, among other example wireless communication devices. The wireless device 302 may be a host device (such as a smartphone, a laptop, or a gaming console, among other examples) and the wireless device 304 may be a display device (such as a head mounted display (HMD) or an XR, VR, AR, or MR glass, among other examples). Additionally, or alternatively, the wireless device 304 may be, include, or be associated with (such as communicatively or operably coupled with) headphones, earbuds, or haptic equipment (such as haptic gloves, among other examples).

In some examples, the wireless device 302 and the wireless device 304 may perform or support split rendering such that an application workload is split between the wireless device 302 and the wireless device 304. For example, in split rendering, an application workload may be split between two or more devices, such as between a host device and a display device (such as an HMD or an AR glass). An application workload may be or include an XR workload, a VR workload, an MR workload, an AR workload, or any other workload for any other application(s) at the wireless device 302 or the wireless device 304.

In some systems, the wireless device 302 and the wireless device 304 may perform or support split rendering in accordance with relative processing powers, capabilities, or availabilities, among other factors, between the wireless device 302 and the wireless device 304. For example, the wireless device 304 may have a relatively lower processing capability as compared to the wireless device 302. Additionally, or alternatively, the wireless device 304 may have relatively weaker heat dissipation capabilities, among other characteristics, as compared to the wireless device 302. In such examples, the wireless device 302 may perform at least a portion of a workload processing (such as to assist the wireless device 304, such as to enable the wireless device 304 to perform a subset of a total amount of workload processing).

For example, in accordance with performing or supporting split rendering, the wireless device 302 may perform (at least a portion of) a rendering 306 of display data (such as one or more visual frames to be displayed to a user at the wireless device 304) and may perform an encoding 308 of the (at least partially) rendered display data to prepare the display data for transport (such as an over-the-air transport) to the wireless device 304. To transport the (at least partially) rendered display data, the wireless device 302 may transmit one or more packets, such as one or more Wi-Fi packets, via a frequency channel 310 (such as a 2.4 GHz, a 5 GHz, or a 6 GHz frequency channel, among other examples). In other words, the wireless device 302 may stream content to the wireless device 304 via a communication channel or otherwise in accordance with a wireless communication protocol after the rendering 306 and the encoding 308, such as via a Wi-Fi channel or in accordance with a Wi-Fi protocol.

The wireless device 304 may receive the one or more packets via the frequency channel 310 and may perform a decoding 314 of the one or more packets to obtain the (at least partially) rendered display data. The wireless device 304 may perform additional rendering (such as if the wireless device 302 performed a partial rendering) and may perform a warping 316 of the display data to provide a clear or expected visual to the user of the wireless device 304. In some aspects, the wireless device 304 may perform the warping 316 to reduce, mitigate, or eliminate a delay between a head movement and an image being displayed by the wireless device 304. In some aspects, the wireless device 304 may transmit, to the wireless device 302 via the frequency channel 310 (which may be the same channel or a different channel as compared to the channel via which the display data is received) a set of parameters 312. The set of parameters 312 may include information indicative of or otherwise associated with one or more degrees-of-freedom (DOF) of the wireless device 304 (such as six DOF, which may be referred to as 6DOF or 6D), pose data (which may relate to the information associated with the DOF of the wireless device 304), one or more red-green-blue (RGB) images, hand tracking (which may be referred to herein as “HT” or “HaT”) data, camera tracking data, or haptic data, among other examples.

In some systems, the wireless device 302 and the wireless device 304 may communicate (such as transmit or receive, or both) data or packets via the frequency channel 310 (or via multiple frequency channels 310) in accordance with one or more TWT sessions. A TWT session may refer to a TWT schedule, such as a schedule of TWT SPs, or any other schedule, set, or sequence of time windows, slots, durations, periods, intervals, or epochs at or within which the wireless device 302 or the wireless device 304 may (expect to) communicate data. In some implementations, the wireless device 302 or the wireless device 304, or both, may (dynamically, semi-persistently, periodically, or aperiodically) adapt (such as update, adjust, or change) one or more TWT sessions. Such changes may include increasing or decreasing a duration of a TWT SP (or any other time slot, duration, period, or interval), increasing or decreasing a periodicity or frequency associated with TWT SPs (or any other time slot, duration, period, interval, or epoch), creating one or more new TWT sessions, merging multiple TWT sessions, or terminating (such as ending or stopping) one or more TWT sessions, among other examples. The wireless device 302 or the wireless device 304, or both, may perform such TWT session adaptation(s) in accordance with one or more communication parameters or one or more objective parameters, or any combination thereof.

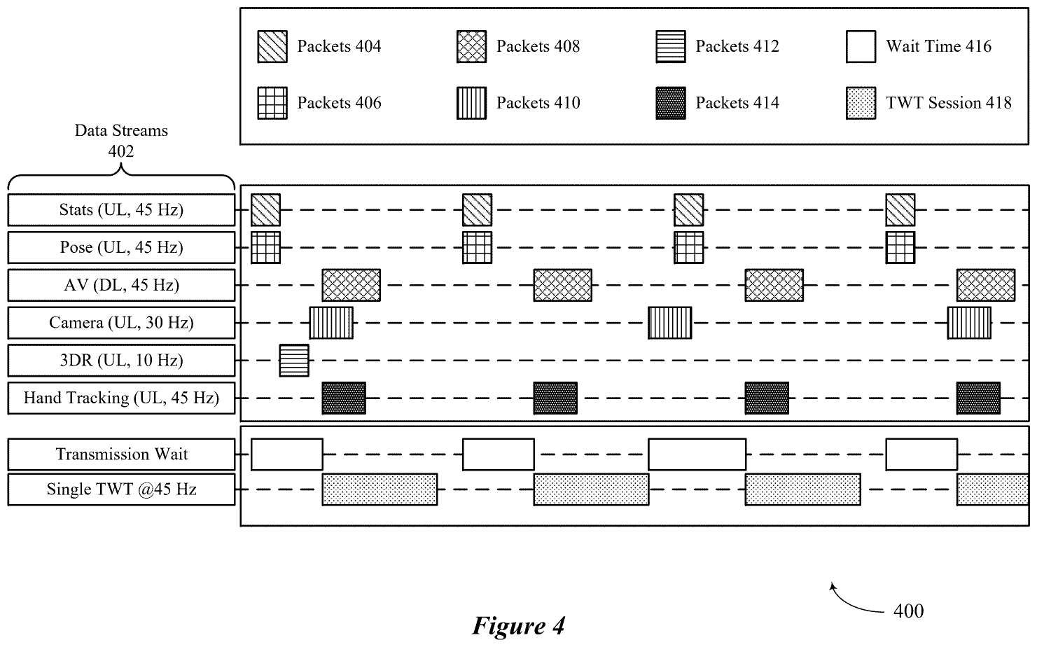

FIG. 4 shows an example processing timeline 400 that supports TWT session adaptation. The processing timeline 400 may implement or be implemented to realize one or more aspects of the wireless communication network 100, the wireless communication network 200, or the system diagram 300. For example, the processing timeline 400 illustrates a processing of a set of data streams 402 and a communication of packets (such as data packets) associated with the set of data streams 402 between two wireless communication devices, such as the wireless device 302 and the wireless device 304. The processing timeline 400 may be a split rendering processing timeline between a host device and a display device, such as a phone-HMD/glass split rendering processing timeline, among other examples.

The set of data streams 402 may be or include data streams associated with an application at the wireless device 302 or the wireless device 304, such as an XR application, a VR application, an MR application, or an AR application. In some examples, the set of data streams 402 may include a first data stream associated with one or more statistics (which may be associated with an uplink, or “UL,” transmission direction and a frequency of 45 Hz), a second data stream associated with pose data (which may be associated with an uplink transmission direction and a frequency of 45 Hz), a third data stream associated with audio-visual (AV) data (which may be associated with a downlink, or “DL,” transmission direction and a frequency of 45 Hz), a fourth data stream associated with camera data (which may be associated with an uplink transmission direction and a frequency of 30 Hz), a fifth data stream associated with 3DR data (which may be associated with an uplink transmission direction and a frequency of 45 Hz), and a sixth data stream associated with hand tracking data (which may be associated with an uplink transmission direction and a frequency of 45 Hz). The set of data streams 402 may include any quantity of data streams without exceeding the scope of the present disclosure, such as a single data stream, two data streams, three data streams, and so on.

Further, the set of data streams 402 may be associated with any combination of uplink and downlink data and any of various frequencies (such as any of various possible data rates, such as data generation rates). For example, pose data may be or include head pose data and, in some systems, may be transmitted at a relatively higher rate (such as approximately 500 Hz) or at a relatively lower rate (such as a rate approximately equal to a render rate) for some synchronization schemes of split rendering. For further example, the wireless device 304 may transmit camera data to the wireless device 302 at a fixed rate, which may differ from a downlink frame rate. For further example, the wireless device 304 may transmit statistics and hand tracking data to the wireless device 302 at different rates.

Each data stream of the set of data streams 402 may be associated with a respective set of packets. For example, the first data stream may be associated with a first set of packets 404, the second data stream may be associated with a second set of packets 406, the third data stream may be associated with a third set of packets 408, the fourth data stream may be associated with a fourth set of packets 410, the fifth data stream may be associated with a fifth set of packets 412, and the sixth data stream may be associated with a sixth set of packets 414. Each respective set of packets may be generated (such as prepared for wireless transmission) at a frequency associated with (such as equal to or approximately equal to) the frequency of the corresponding data generation. For example, the first set of packets 404 may be associated with a frequency of 45 Hz and the fourth set of packets 410 may be associated with a frequency of 30 Hz. A frequency of data generation of 45 Hz may be associated with a period of 22.22 milliseconds (ms) and a frequency of data generation of 30 Hz may be associated with a period of 33.33 ms.

Further, packets associated with different data streams of the set of data streams 402 may have different packet lengths, such as different transmit or receive (Tx/Rx) time durations. For example, the first set of packets 404 may be associated with a packet length of (approximately) 2 ms, the second set of packets 406 may be associated with a packet length of (approximately) 2 ms, the third set of packets 408 may be associated with a packet length of (approximately) 4 ms, the fourth set of packets 410 may be associated with a packet length of (approximately) 3 ms, the fifth set of packets 412 may be associated with a packet length of (approximately) 2 ms, and the sixth set of packets 414 may be associated with a packet length of (approximately) 3 ms.

In some systems, the wireless device 302 and the wireless device 304 may schedule, support, or otherwise communicate in accordance with or using a single TWT session 418 (which may be associated with an SP frequency of 45 Hz and a duration of, for example, 8 ms). In such systems, in split rendering, multiple uplink and downlink transmissions may occur at different rates within a single TWT SP. In other words, with a single (fixed) TWT scheme, the wireless device 302 and the wireless device 304 may try to align uplink and downlink clients (such as uplink and downlink data streams) to a fixed TWT window for data transmission. Aligning uplink and downlink transmissions of various data streams (which may be running at different frequencies, rates, or cadences) may be challenging and, in some scenarios, not possible. For example, two or more of pose data, AV data, camera data, hand tracking data, and 3DR data may not be aligned (at least not consistently or regularly) due to different data streams potentially running at different cadences. Such challenges may result in an unsuitable or relatively poor end-to-end performance, increased latencies, and an unpleasant UX. For example, such challenges may result in potentially lengthy or inconsistent transmission wait times 416, which may refer to a duration within which data is waiting to be transmitted (and thus delayed relative to when the data was generated).

Further, with a single (fixed) TWT scheme, the wireless device 302 and the wireless device 304 may lack an ability to adapt based on network conditions. For example, in scenarios in which an OBSS condition arises, use of a single (fixed) TWT scheme may result in the wireless device 302 and the wireless device 304 experiencing a negative UX impact, such as a stalled or glitchy application, as the wireless device 302 and the wireless device 304 may be unable to dynamically change an OBSS condition TWT window (such as a TWT window or SP within which an OBSS condition, such as OBSS interference, arises). In scenarios in which the wireless device 302 and the wireless device 304 experience such negative UX impacts, the wireless device 302 and the wireless device 304 may fail to realize or experience some benefits of TWT because TWT windows may be set larger than necessary (such as to proactively accommodate for different data stream data generation rates or adverse network conditions) or because TWT may be disabled (due to the wireless device 302 and the wireless device 304 being unable to address the challenges of TWT in split rendering scenarios).

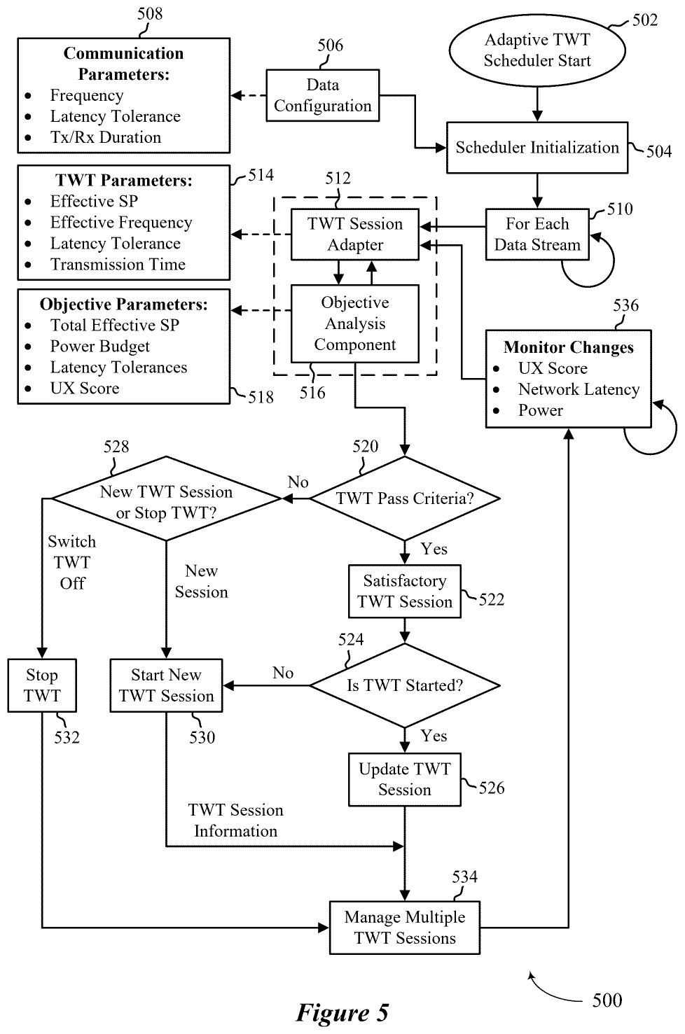

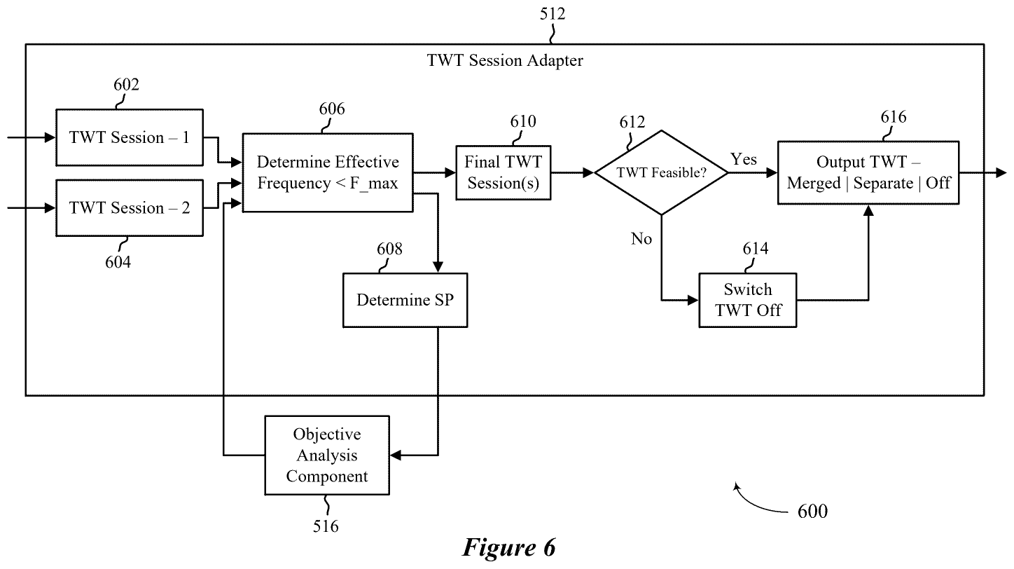

Accordingly, in some implementations of the present disclosure, the wireless device 302 or the wireless device 304, or both, may support one or more configuration-or signaling-based mechanisms according to which the wireless device 302 or the wireless device 304, or both, may dynamically adapt one or more TWT sessions in accordance with one or more sets of communication parameters, one or more sets of objective parameters, one or more network conditions, one or more device conditions or constraints, or any combination thereof. In accordance with the example mechanisms disclosed herein, the wireless device 302 and the wireless device 304 may realize or achieve greater power benefits of TWT, among other benefits, by employing an adaptive TWT scheme for one or more of various use cases, including for split processing. In some examples, the wireless device 302 or the wireless device 304, or both, may support a TWT session adapter and an objective analysis component (such as a loss/cost reducer or minimizer) according to which the wireless device 302 or the wireless device 304 may determine whether to create a new TWT session, merge two or more TWT sessions, update a TWT session, or set a state associated with usage of TWT sessions (such as a state associated with TWT operation), among other aspects. Additional details relating to such a TWT session adapter and an objective analysis component are illustrated and described herein, including by and with reference to FIGS. 5 and 6.

FIG. 5 shows an example process flow 500 that supports TWT session adaptation. The process flow 500 may implement or be implemented to realize one or more aspects of the wireless communication network 100, the wireless communication network 200, the system diagram 300, or the processing timeline 400. For example, the wireless device 302 or the wireless device 304, or both, may implement the process flow 500 as part of supporting an adaptive TWT scheme. Further, while some steps of the process flow 500 are described herein as being performed by the wireless device 302 for purpose of example, the wireless device 304 may additionally perform the same or similar steps. Alternatively, in some implementations, the wireless device 302 may perform a first subset of the process flow 500 and the wireless device 304 may perform a second subset (such as a remaining portion) of the process flow 500. The wireless device 302 and the wireless device 304 may communicate information determined or obtained by performing the operations of the process flow 500.

At 502, the wireless device 302 (or the wireless device 304, or both) may start an adaptive TWT scheduler. The adaptive TWT scheduler may be associated with one or more components of the wireless device 302 or may trigger, activate, or cause the wireless device 302 to perform one or more operations, or any combination thereof.

At 504, the wireless device 302 may initialize a scheduler, such as a TWT scheduler. In some aspects, the wireless device 302 may inform the scheduler of a data configuration 506, such as a configuration of one or more data streams associated with an application at the wireless device 302. In other words, the wireless device 302 may provide the scheduler 504 with one or more data configurations 506. A data configuration 506 may include, be associated with, or be based on a set of communication parameters 508. A set of communication parameters 508 may include one or more of a frequency, a latency tolerance, and a Tx/Rx duration. In some examples, each data configuration 506 may be associated with a respective data stream of the application at the wireless device 302. In such examples, each data stream may be associated with a respective set of communication parameters 508.

For example, a first set of communication parameters 508 may include one or more of a frequency associated with a first data stream, a latency tolerance associated with the first data stream, and a Tx/Rx duration associated with the first data stream. For further example, a second set of communication parameters 508 may include one or more of a frequency associated with a second data stream, a latency tolerance associated with the second data stream, and a Tx/Rx duration associated with the second data stream, among other examples. The wireless device 302 may obtain information indicative of one or more sets of communication parameters 508 in accordance with retrieving the one or more sets of communication parameters 508 from one or more memories associated with (such as accessible by) the wireless device 302, receiving information indicative of the one or more sets of communication parameters 508 from one or more other (wired or wireless) devices, generating or selecting the one or more sets of communication parameters 508 based on one or more configurations 506 (or other information received or obtained by the wireless device 302), or any combination thereof.

At 510, the wireless device 302 may input or provide each data stream to a TWT session adapter 512. In some aspects, the TWT session adapter 512 may reference, consider, account for, or factor in a set of TWT parameters 514. For example, the wireless device 302 may provide the set of TWT parameters 514 to the TWT session adapter 512 and the TWT session adapter 512 may adapt, create, merge, start, or terminate one or more TWT sessions in accordance with at least the set of TWT parameters 514. The set of TWT parameters 514 may be associated with or based on one or more active (such as current or existing) TWT sessions, one or more candidate TWT sessions, or any combination thereof. The set of TWT parameters 514 may include one or more of an effective SP, an effective frequency, a latency tolerance, and a transmission time, among other examples.

The TWT session adapter 512 may be coupled with, may interface with, or may otherwise be associated with an objective analysis component 516, which may be equivalently referred to herein, operate, or function as a lost/cost reducer or a loss/cost minimizer (such as to reduce a loss or cost associated with one or more TWT sessions to satisfy one or more thresholds or constraints). The objective analysis component 516 may reference, consider, account for, or factor in a set of objective parameters 518. For example, the wireless device 302 may provide the set of objective parameters 518 to the objective analysis component 516 and the objective analysis component 516 may attempt to reduce or minimize any incurred, determined, or calculated losses or costs based on the set of objective parameters 518. The set of objective parameters 518 may be associated with or based on one or more active (such as current or existing) TWT sessions, one or more candidate TWT sessions, one or more device constraints or metrics, one or more network conditions, or any combination thereof. The set of objective parameters 518 may include one or more of a total effective SP, a power budget metric associated with a set of TWT sessions, the wireless device 302, or the wireless device 304, one or more latency tolerances associated with the set of data streams, a UX score at the wireless device 302 or the wireless device 304, and a thermal metric associated with the wireless device 302 or the wireless device 304, among other examples. In some implementations, the objective analysis component 516 may output a TWT session that satisfies one or more constraints or parameters.

At 520, the wireless device 302 may determine, identify, calculate, select, or otherwise ascertain whether a TWT session (or TWT operation more generally) passes one or more criteria, such as whether a TWT session (such as an initially or preliminarily created independent TWT session, or such as TWT operation more generally) satisfies one or more data-or device-related constraints or thresholds. Data-related constraints or thresholds may include or be based on a latency tolerance, an effective SP or frequency, a transmission time, or a UX score, among other examples. Device-related constraints or thresholds may include or be based on a power budget of the wireless device 302 or the wireless device 304, a thermal budget of the wireless device 302 or the wireless device 304, or a processing availability (such as utilization percentage of one or more central processing units (CPUs), one or more graphics processing units (GPUs), or one or more neural processing units (NPUs)) at the wireless device 302 or the wireless device 304, among other examples. In some aspects, the wireless device 302 may analyze TWT operation at 520 to determine whether to create a create/terminate/adapt one or more TWT sessions.

At 522, if the TWT session passes one or more criteria (520—Yes), the wireless device 302 may determine that the TWT session (or TWT operation more generally) is satisfactory. In other words, the wireless device 302 may determine that the TWT session (or TWT operation) satisfies the criteria at 520. At 524, the wireless device 302 may determine, identify, calculate, select, or otherwise ascertain whether the TWT session (or TWT operation) has been started. At 526, if the TWT session (or TWT operation) has been started (524—Yes), the wireless device 302 may (conditionally or selectively) update the TWT session (or multiple TWT sessions) based on one or more metrics, constraints, or thresholds.

At 528, in examples in which the wireless device 302 determines that the TWT session (or TWT operation more generally) fails to satisfy the criteria at 520 (520—No), the wireless device 302 may determine, identify, calculate, select, or otherwise ascertain whether to start (such as generate or create) a new TWT session or to stop (such as terminate, pause, or cease) usage of TWT sessions. At 530, in examples in which the wireless device 302 determines to start a new TWT session at 528 (528-New Session) or in examples in which the wireless device 302 determines that a TWT session (or TWT operation) has not been started at 524 (524—No), the wireless device 302 may start a new TWT session. Alternatively, at 532, the wireless device 302 may stop usage of TWT sessions in accordance with determining to switch usage of TWT sessions off at 28 (528—Switch TWT Off). In examples in which the wireless device 302 stops usage of TWT sessions, the wireless device 302 may set a state associated with usage of TWT sessions to an OFF state.

At 534, the wireless device 302 may continuously, periodically, aperiodically, or semi-persistently manage one or multiple TWT sessions (such as over time). For example, the wireless device 302, using one or more components or modules associated with the TWT session adapter 512 and the objective analysis component 516, may make or perform decisions based on input parameters for each data stream to be transmitted and may determine, schedule, configure, or generate TWT sessions as merged or multiple TWT sessions to be used for wireless communication.

In some implementations, the wireless device 302 may make or perform the decisions for merging or shifting TWT sessions or for switching usage of TWT sessions to an “OFF” state, among other examples, based on various parameters associated with each data stream during runtime. Such parameters may include one or more of a transmission frequency and an SP (such as a Wi-Fi “ON” duration) constraint or expectation, a potential power impact of a new TWT session, a latency tolerance of data in a data or application pipeline (such as an XR pipeline), a TWT SP separation for or between multiple TWT sessions (such as to account for a wake-to-sleep-to-wake latency at the wireless device 302), a UX score, and a wireless (such as Wi-Fi) transmission rate and latencies. The UX score may include, be based on, or pertain to one or more of a motion-to-render-to-photon (M2R2P) latency at the wireless device 302, a transmission latency, and a CPU-GPU-NPU utilization, among other examples.

At 536, the wireless device 302 may additionally monitor for one or more of various changes over time. For example, the wireless device 302 may continuously, periodically, aperiodically, or semi-persistently monitor for changes to one or more of a UX score, a network latency, one or more power metrics, and one or more thermal metrics, among other examples. In other words, the wireless device 302, using one or more components or modules associated with the TWT session adapter 512 and the objective analysis component 516, may determine an initial set of TWT sessions and may (subsequently) intermittently update, adapt, adjust, or change the TWT sessions to satisfy one or more constraints or thresholds associated with one or more of a UX score, transmission latencies, power metrics, and thermal metrics.

FIG. 6 shows an example process flow 600 that supports TWT session adaptation. The process flow 600 may implement or be implemented to realize one or more aspects of the wireless communication network 100, the wireless communication network 200, the system diagram 300, the processing timeline 400, and the process flow 500. For example, the wireless device 302 or the wireless device 304, or both, may implement the process flow 600 via or in accordance with the TWT session adapter 512 and the objective analysis component 516, as illustrated by and described in more detail with reference to FIG. 5. Further, while some steps of the process flow 600 are described herein as being performed by the wireless device 302 for purpose of example, the wireless device 304 may additionally perform the same or similar steps. Alternatively, in some implementations, the wireless device 302 may perform a first subset of the process flow 600 and the wireless device 304 may perform a second subset (such as a remaining portion) of the process flow 600.

In some implementations, the wireless device 302 may initially determine (such as generate, schedule, create, or consider as candidates) a first TWT session 602 and a second TWT session 604. In some aspects, the wireless device 302 may determine the first TWT session 602 and the second TWT session 604 independently, such as based on two different data streams. For example, the wireless device 302 may determine the first TWT session 602 based on a first data stream (such as based on a first set of set of communication parameters 508 associated with the first data stream) and may determine the second TWT session 604 based on a second data stream (such as based on a second set of set of communication parameters 508 associated with the second data stream). In other words, the wireless device 302 may initially assume that each data stream is (or is associated with) an independent TWT session.

At 606, the wireless device 302 may determine an effective frequency associated with the first TWT session 602 and the second TWT session 604, such as if the first TWT session 602 and the second TWT session 604 were merged into a single TWT session. For example, the wireless device 302 may determine a non-overlapping transmission frequency while considering a latency tolerance and transmission time associated with the first and second data streams. In some aspects, the effective frequency associated with the first TWT session 602 and the second TWT session 604 may be less than an upper limit or maximum frequency (“F_max” in FIG. 6) associated with the first TWT session 602 and the second TWT session 604 (such as less than a greater of a first frequency associated with the first TWT session 602 and a second frequency associated with the second TWT session 604).

At 608, the wireless device 302 may determine an SP (such as an SP duration) associated with the first TWT session 602, the second TWT session 604, or a merged TWT session. For example, the wireless device 302 may determine an overall “ON” time (such as an overall Wi-Fi “ON” time) to be the same or approximately the same as a transmission time associated with the first data stream or second data stream, or both. In other words, the wireless device 302 may determine an SP based on a total transfer time, such as a total data transfer time that is expected to fully transmit packets associated with the first data stream or second data stream, or both.

The wireless device 302 may input or provide the effective frequency or the SP, or both, to the objective analysis component 516. In some implementations, the wireless device 302 may use the objective analysis component 516 to reduce (such as to minimize, such as to reduce below a threshold) one or more of a power consumption at the wireless device 302, a transmission latency associated with the first and second data streams, and a UX impact, among other examples.

At 610, the wireless device 302 may determine one or more updated or finalized TWT sessions. “Finalized” TWT sessions may refer to TWT sessions that are determined to satisfy at least data-related constraints or thresholds associated with the first and second data streams or at least device-related constraints, or both. The TWT sessions that the wireless device 302 determines at 610 may include the first TWT session 602 and the second TWT session 604 or may include a merged TWT session (based on a merging of the first TWT session 602 and the second TWT session 604). For example, the wireless device 302 may attempt to merge the first TWT session 602 and the second TWT session 604 into a single TWT session by adjusting one or more of a position of transmission (such as a position or location of the SPs) as per one or more of the latency tolerance(s), an expected transmission time (such as a Tx/Rx duration, which may inform the determined SP duration), and a frequency (such as the TWT frequency, which may be selected as a maximum or greater frequency or an effective frequency between the two data streams). The wireless device 302 may merge the first TWT session 602 and the second TWT session 604 as per a maximum (such as greater) frequency or an effective frequency at a suitable SP. If the wireless device 302 is unable to merge the first TWT session 602 and the second TWT session 604 into a single TWT session, the wireless device 302 may schedule, start, or create separate TWT sessions.

At 612, the wireless device 302 may determine, identify, calculate, select, or otherwise ascertain whether the updated or finalized TWT sessions are feasible. Such a feasibility assessment may be based on one or more of a power budget or constraint, a thermal budget or constraint, and a UX score. For example, the wireless device 302 may determine whether the updated or finalized TWT sessions satisfy one or more constraints of the wireless device 302.

At 614, in examples in which the wireless device 302 determines that the updated or finalized TWT sessions are not feasible, the wireless device 302 may set a state associated with usage of TWT sessions to an OFF state. In accordance with setting the usage of TWT sessions to the OFF state, the wireless device 302 may contend for channel access via one or more other mechanisms and refrain from using TWT-based mechanisms to obtain channel access.

At 616, the wireless device 302 may output the created TWT sessions or may output an indication that the wireless device 302 has set the state associated with the usage of TWT sessions to the OFF state. For example, the wireless device 302, using the TWT session adapter 512, may output an indication of a merged TWT session, of separate TWT sessions, or of a “TWT OFF” indication. The TWT session adapter 512 may output such TWT information to one or more other components of the wireless device 302. Additionally, or alternatively, the wireless device 302 may transmit such TWT information to one or more other devices, such as to the wireless device 304. The wireless device 302 and the wireless device 304 may communicate with each other (such as transmit or receive data) in accordance with the TWT information.

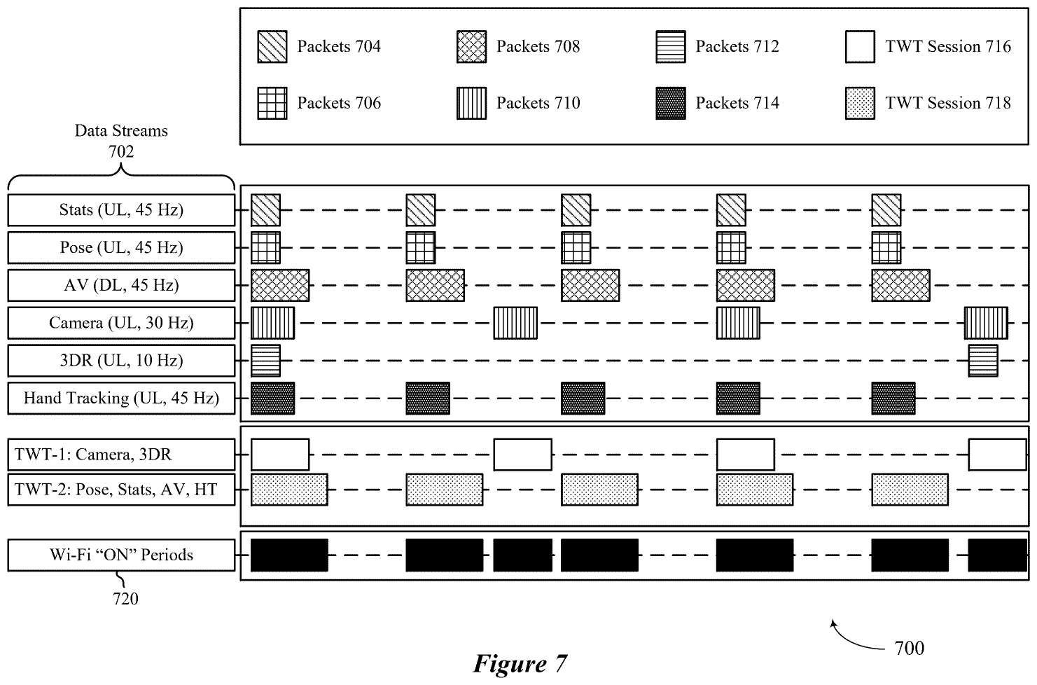

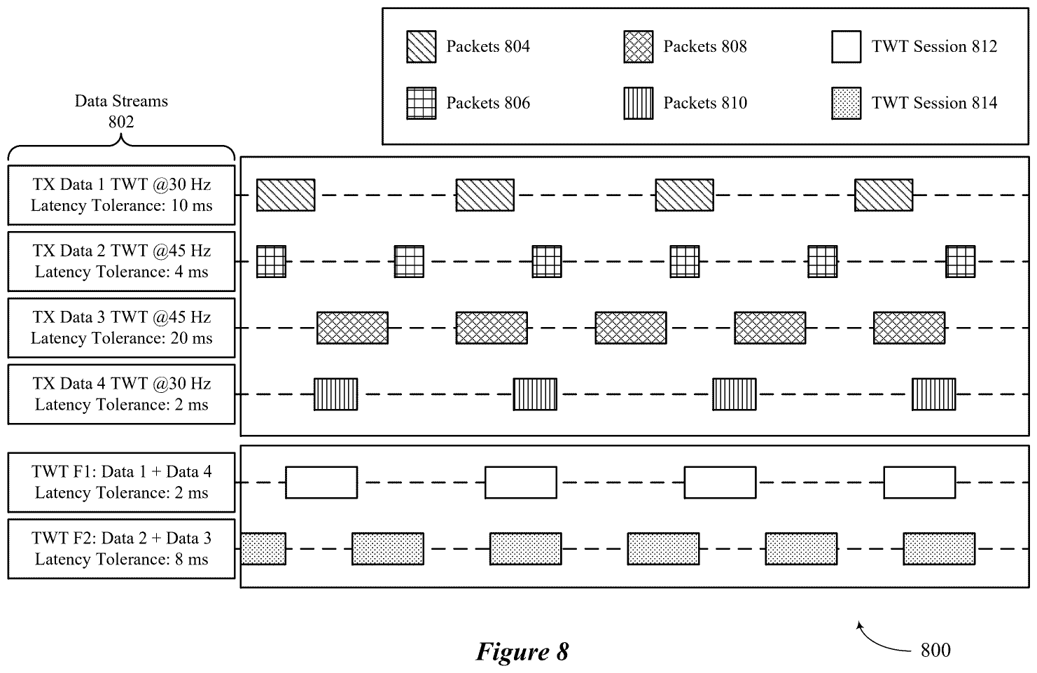

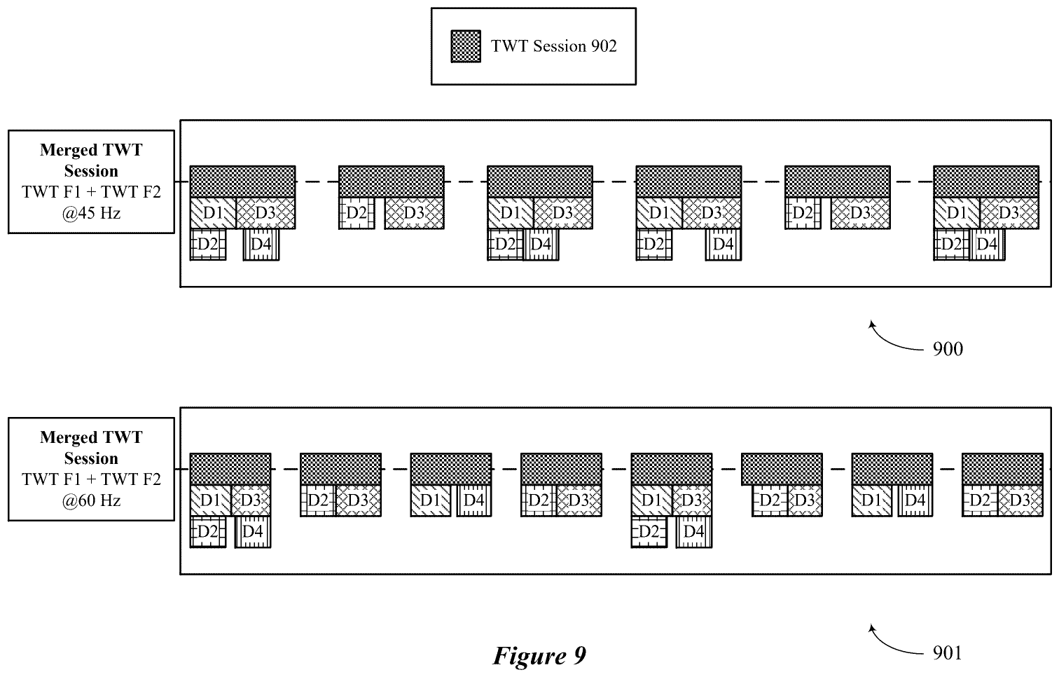

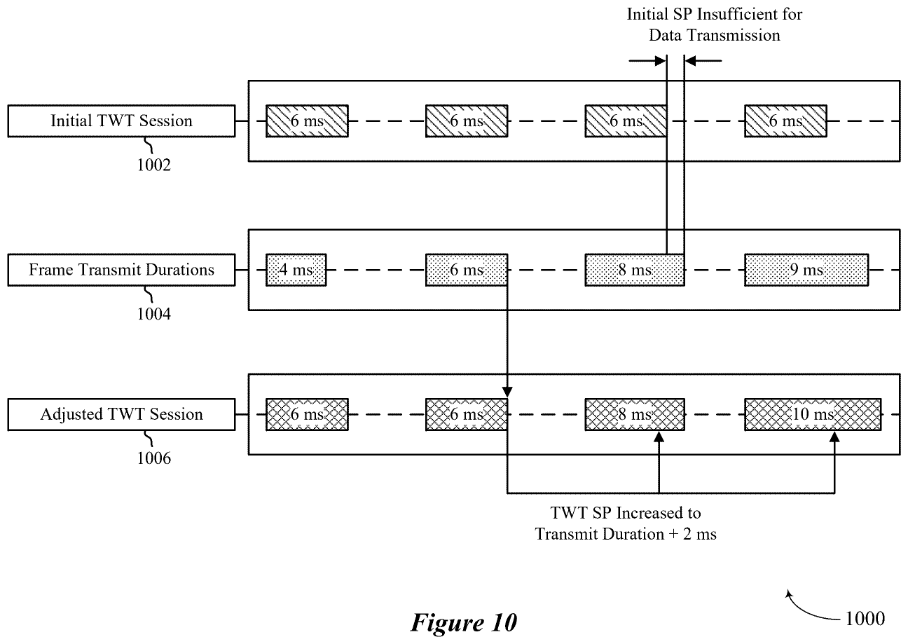

FIG. 7 shows an example TWT session determination scheme 700 that supports TWT session adaptation. The TWT session determination scheme 700 may implement or be implemented to realize one or more aspects of the wireless communication network 100, the wireless communication network 200, the system diagram 300, the processing timeline 400, the process flow 500, and the process flow 600. For example, the TWT session determination scheme 700 illustrates a communication of packets associated with a set of data streams 702 between two wireless communication devices, such as the wireless device 302 and the wireless device 304, in accordance with TWT sessions determined in accordance with example implementations disclosed herein.

As illustrated in the example of the TWT session determination scheme 700, each data stream of the set of data streams 702 may be associated with a respective set of packets. For example, a first data stream of the set of data streams 702 may be associated with a first set of packets 704, a second data stream of the set of data streams 702 may be associated with a second set of packets 706, a third data stream of the set of data streams 702 may be associated with a third set of packets 708, a fourth data stream of the set of data streams 702 may be associated with a fourth set of packets 710, a fifth data stream of the set of data streams 702 may be associated with a fifth set of packets 712, and a sixth data stream of the set of data streams 702 may be associated with a sixth set of packets 714. The set of data streams 702 may include any quantity of data streams without exceeding the scope of the present disclosure, such as a single data stream, two data streams, three data streams, and so on. Further, the set of data streams 702 may be associated with any combination of uplink and downlink data and any of various frequencies (such as any of various possible data rates, such as data generation rates).

In accordance with some example implementations, the wireless device 302 or the wireless device 304 may determine a set of TWT sessions associated with the set of data streams 702. In some examples, the wireless device 302 or the wireless device 304, or both, may determine the set of TWT sessions based on the respective set of communication parameters 508 associated with each data stream of the set of data streams 702. In such examples, the set of TWT sessions may be based on one or more sets of communication parameters 508, with each set of communication parameters 508 associated with a respective data stream of the set of data streams 702. The wireless device 302 or the wireless device 304 may use, operate, or employ one or more adaptive TWT components or modules to determine the set of TWT sessions.

For example, the wireless device 302 or the wireless device 304, or both, may calculate an expected latency if data of a current data stream (such as a data stream or client being considered at 510 of the process flow 500) is transmitted within TWT windows of one of a set of existing (already or previously created and active) TWT sessions. A previously created and active TWT session may be a TWT session that was previously established to serve another data stream of the set of data streams 702. The wireless device 302 or the wireless device 304, or both, may compare the expected latency with a latency tolerance, such as a latency tolerance (such as a latency tolerance limit) indicated by a set of communication parameters 508 corresponding to the current data stream.

In examples in which the latency tolerance limit of the current data stream can be met or satisfied by transmitting data of the current data stream within TWT windows of an existing TWT session, the wireless device 302 or the wireless device 304, or both, may refrain from creating a new TWT session for the current data stream. Instead, the wireless device 302 or the wireless device 304, or both, may transmit data of the current data stream within the TWT windows of the existing TWT session. Alternatively, in examples in which the latency tolerance limit of the current data stream cannot be met or satisfied by transmitting data of the current data stream within TWT windows of an existing TWT session (such as any existing TWT session), the wireless device 302 or the wireless device 304, or both, may create a new TWT session to serve the current data stream.

Additionally, or alternatively, the wireless device 302 or the wireless device 304 may consider a set of objective parameters 518 associated with one or more existing/candidate TWT sessions to determine the set of TWT sessions (such that, for example, the created TWT sessions satisfy one or more constraints of the wireless device 302 or the wireless device 304). For example, the wireless device 302 or the wireless device 304 may consider a power/thermal budget of the wireless device 302 or the wireless device 304 to determine whether to open a new TWT session (such as a new TWT window). For example, if the wireless device 302 or the wireless device 304 determines that a new TWT session cannot be accommodated due to a power/thermal budget constraint at the wireless device 302 or the wireless device 304, the wireless device 302 or the wireless device 304 may refrain from creating a new TWT session. In such examples, the wireless device 302 or the wireless device 304 may balance meeting a power/thermal budget constraint with meeting a performance (such as latency) target, such that the wireless device 302 or the wireless device 304 may (temporarily) transmit data within an existing TWT window that provides a relatively lowest latency if a new TWT session is unable to be created due to the power/thermal budget constraint. A power budget constraint may refer to a percentage battery usage or a threshold rate of power consumption, among other examples. A thermal budget constraint may refer to a threshold temperature or a threshold rate of temperature increase, among other examples.

In the example of the TWT session determination scheme 700, the wireless device 302 or the wireless device 304 may determine a set of TWT sessions including a TWT session 716 and a TWT session 718 to serve the set of data streams 702. As illustrated in the example of the TWT session determination scheme 700, the wireless device 302 or the wireless device 304 may determine the TWT session 716 to serve data streams associated with camera data and 3DR data and may determine the TWT session 718 to serve data streams associated with pose data, statistics data, AV data, and hand tracking data. In accordance with the TWT session 716 and the TWT session 718, the wireless device 302 and the wireless device 304 may be associated with Wi-Fi “ON” periods 720, which may be time periods within which the wireless device 302 and the wireless device 304 are in an active state or mode (and potentially actively transmitting or receiving data). The wireless device 302 or the wireless device 304 may determine to create the TWT session 716 and the TWT session 718 based on the Wi-Fi “ON” periods 720 satisfying a power/thermal budget constraint at the wireless device 302 or the wireless device 304, or at both.

In some examples, the wireless device 302 or the wireless device 304 may determine a TWT window/SP duration based on the Wi-Fi “ON” periods 720, such as based on the effective Wi-Fi “ON” time. For example, for a TWT session associated with a frequency of 45 Hz and a TWT window/SP duration of 8 ms, an effective Wi-Fi “ON” time may be equal to 45*8=360ms, which may be understood as 36% of each second. In such examples, if the TWT session is adjusted, adapted, or updated to have a frequency of 60 Hz, the wireless device 302 or the wireless device 304 may set a TWT window/SP duration for the TWT session to be equal to 6 ms to achieve or approximate the same 36% of Wi-Fi “ON”time.

FIG. 8 shows an example TWT session determination scheme 800 that supports TWT session adaptation. The TWT session determination scheme 800 may implement or be implemented to realize one or more aspects of the wireless communication network 100, the wireless communication network 200, the system diagram 300, the processing timeline 400, the process flow 500, and the process flow 600. For example, the TWT session determination scheme 800 illustrates a communication of packets associated with a set of data streams 802 between two wireless communication devices, such as the wireless device 302 and the wireless device 304, in accordance with TWT sessions determined in accordance with example implementations disclosed herein.

As illustrated in the example of the TWT session determination scheme 800, each data stream of the set of data streams 802 may be associated with a respective set of packets. For example, a first data stream of the set of data streams 802 may be associated with a first set of packets 804, a second data stream of the set of data streams 802 may be associated with a second set of packets 806, a third data stream of the set of data streams 802 may be associated with a third set of packets 808, and a fourth data stream of the set of data streams 802 may be associated with a fourth set of packets 810. The different data streams may be associated with different packet durations. For example, the first set of packets 804 may be associated with packet durations of 4 ms, the second set of packets 806 may be associated with packet durations of 2 ms, the third set of packets 808 may be associated with packet durations of 5 ms, and the fourth set of packets 810 may be associated with packet durations of 3 ms. The set of data streams 802 may include any quantity of data streams without exceeding the scope of the present disclosure, such as a single data stream, two data streams, three data streams, and so on. Further, the set of data streams 802 may be associated with any combination of uplink and downlink data and any of various frequencies (such as any of various possible data rates, such as data generation rates).

In some examples, the first data stream may be associated with a frequency of 30 Hz and a latency tolerance of 10 ms, the second data stream may be associated with a frequency of 45 Hz and a latency tolerance of 4 ms, the third data stream may be associated with a frequency of 45 Hz and a latency tolerance of 20 ms, and the fourth data stream may be associated with a frequency of 30 Hz and a latency tolerance of 2 ms. In some implementations, the wireless device 302 or the wireless device 304 may initially assume or determine an independent TWT session for each data stream of the set of data streams 802, such that each of the four data streams within the set of data streams 802 may be associated with a respective initial or preliminary independent TWT session.

If an effective frequency of multiple TWT windows (such as TWT windows across multiple TWT sessions) is greater than a threshold frequency, TWT operation may provide relatively small power savings. To achieve greater power savings, the wireless device 302 or the wireless device 304 may attempt to merge two or more of the initial or preliminary independent TWT sessions. In some implementations, the wireless device 302 or the wireless device 304 may determine to merge the initial or preliminary independent TWT sessions associated with the first and fourth data stream into a TWT session 812 and may determine to merge the initial or preliminary independent TWT sessions associated with the second and third data streams into a TWT session 814. For example, the wireless device 302 or the wireless device 304 may fuse multiple TWT windows into a single TWT session based on one or more of transmission cadences, a Tx/Rx durations, and latency tolerances, among other examples.

The TWT session 812 may be associated with a frequency of 30 Hz (matching the frequency of the first and fourth data streams) and the TWT session 814 may be associated with a frequency of 45 Hz (matching the frequency of the second and third data streams). In some examples, the TWT session 812 may be associated with a latency tolerance of 2 ms and the TWT session 814 may be associated with a latency tolerance of 8 ms. Further, in some examples, the TWT session 812 may be associated with a TWT window/SP duration of 7ms and the TWT session 814 may be associated with a TWT window/SP duration of 7ms.

In some examples, if merging TWT windows is feasible, the wireless device 302 or the wireless device 304 may use, for a frequency of a resulting merged TWT session, either a relatively greater (a relative maximum) frequency of the TWT sessions being merged or an effective frequency of the TWT sessions being merged. Additional details relating to such a determination of the frequency of the resulting merged TWT session are illustrated and described herein, including by and with reference to FIG. 9.

FIG. 9 shows example TWT session determination schemes 900 and 901 that support TWT session adaptation. In some aspects, the TWT session determination schemes 900 and 901 illustrate options according to which the wireless device 302 or the wireless device 304 may merge the TWT session 812 and the TWT session 814, as illustrated by and described with reference to FIG. 8, into a TWT session 902 (which may be understood as a merged TWT session). In the illustration of FIG. 9, “D1” may correspond to the first data stream of the set of data streams 802, “D2” may correspond to the second data stream of the set of data streams 802, “D3” may correspond to the third data stream of the set of data streams 802, and “D4” may correspond to the fourth data stream of the set of data streams 802.

In accordance with the TWT session determination scheme 900, the wireless device 302 or the wireless device 304 may merge the TWT session 812 and the TWT session 814 at a maximum frequency between the TWT session 812 and the TWT session 814. In such examples, the TWT session 902 may be associated with a frequency that is equal to a relatively greater of a first frequency associated with the TWT session 812 and a second frequency associated with the TWT session 814. Accordingly, in examples in which the TWT session 812 is associated with a frequency of 30 Hz and the TWT session 814 is associated with a frequency of 45 Hz, the TWT session 902 may be associated with a frequency of 45 Hz (as max(30,45)=45). For further example, if a set of TWT sessions being merged are associated with frequencies of 15 Hz, 30 Hz, and 45 Hz, the merged TWT session may be associated with a frequency of 45 Hz (as max(15,30,45)=45). In accordance with the TWT session determination scheme 900, a TWT window/SP duration of the TWT session 902 may be 10 ms.

In accordance with the TWT session determination scheme 901, the wireless device 302 or the wireless device 304 may merge the TWT session 812 and the TWT session 814 at an effective frequency between the TWT session 812 and the TWT session 814. Such an effective frequency may be a maximum or uppermost overlapping frequency achieved after (such as based on) superimposing a set of transmission frequencies. Accordingly, in examples in which the TWT session 812 is associated with a frequency of 30 Hz and the TWT session 814 is associated with a frequency of 45 Hz, the TWT session 902 may be associated with a frequency of 60 Hz. For further example, if a set of TWT sessions being merged are associated with frequencies of 15 Hz, 30 Hz, and 45 Hz, the merged TWT session may be associated with a frequency of 60 Hz. In accordance with the TWT session determination scheme 901, a TWT window/SP duration of the TWT session 902 may be 8 ms.

FIG. 10 shows an example TWT session determination scheme 1000 that supports TWT session adaptation. The TWT session determination scheme 1000 may implement or be implemented to realize one or more aspects of the wireless communication network 100, the wireless communication network 200, the system diagram 300, the processing timeline 400, the process flow 500, and the process flow 600. For example, the TWT session determination scheme 1000 illustrates a mechanism according to which the wireless device 302 or the wireless device 304, or both, may dynamically adjust a TWT session based on one or more network or channel conditions.

For example, the wireless device 304 or the wireless device 304 may determine, create, or schedule an initial TWT session 1002 to serve a data stream associated with frame transmit durations 1004. The initial TWT session 1002 may be associated with a first TWT window/SP duration. As illustrated in the example of the TWT session determination scheme 1000, the first TWT window/SP duration may be 6 ms. Within a first time period, the initial TWT session 1002 may suitably serve the data stream in accordance with the first TWT window/SP duration exceeding or equaling the frame transmit durations 1004, which may initially be 4 ms.

In some deployments, the wireless device 302 or the wireless device 304 may experience an OBSS scenario, such as interference caused by one or more other (nearby) wireless devices. In examples in which the wireless device 302 or the wireless device 304 measures interference (such as greater than a threshold amount of interference, or another indication of channel occupancy) on a first wireless channel, the wireless device 302 or the wireless device 304 may switch from the first wireless channel to a second wireless channel for subsequent communication of the data stream. In such examples, if the second channel is a lower frequency channel as compared to the first channel, the wireless device 302 or the wireless device 304 may determine that frame transmit durations 1004 (such as streaming time) may increase. For example, due to OBSS conditions, the frame transmit durations 1004 may increase from 4 ms, such as to 6 ms, 8 ms, or 9 ms.

Accordingly, the wireless device 302 or the wireless device 304 may determine that the TWT window/SP durations of the initial TWT session 1002 will become insufficient for the data transmission and, in some implementations, may use an adjusted TWT session 1006 instead of the initial TWT session 1002 to serve the data stream. In accordance with the adjusted TWT session 1006, the wireless device 302 or the wireless device 304 may increase a TWT window/SP duration to be able to transmit the data that is queued for a TWT window/SP within that TWT window/SP. For example, the wireless device 302 or the wireless device 304 may increase the TWT window/SP duration in accordance with switching from a higher frequency channel to a lower frequency channel or in accordance with otherwise expecting relatively longer frame transmit durations 1004 (based on, for example, greater channel or network interference or weaker signal strengths). In some implementations, the wireless device 302 or the wireless device 304 may increase the TWT window/SP duration to be equal to a previous frame transmit duration 1004 plus X ms, with X being any numeric value, such as 2.

If the wireless device 302 or the wireless device 304 measures or otherwise determines that channel conditions return to normal (such as to a level measured prior to experiencing the OBSS condition) or if the wireless device 302 or the wireless device 304 switches from a lower frequency channel to a higher frequency channel, the wireless device 302 or the wireless device 304 may determine that the frame transmit durations 1004 may decrease. In such scenarios, the wireless device 302 or the wireless device 304 may leverage the adjusted TWT session 1006 to shorten a TWT window/SP duration. By dynamically lengthening or shortening TWT window/SP durations using the adjusted TWT session 1006, the wireless device 302 or the wireless device 304 may balance high performance (such as low latency) with device power savings depending on the operating/measured channel or network conditions. Thus, in such implementations, ON and OFF periods of the wireless device 302 or the wireless device 304 may vary with varying network conditions (such as due to an OBSS condition or congestion).

Additionally, or alternatively, the wireless device 302 or the wireless device 304 may use the adjusted TWT session 1006 to dynamically increase or decrease TWT window/SP durations based on one or more other parameters, such as a roundtrip time or a streaming latency. For example, the wireless device 302 or the wireless device 304 may determine or calculate a roundtrip time or a streaming latency and may adjust a TWT window/SP duration based on the roundtrip time or the streaming latency such that data that is queued for a TWT window/SP is able to be transmitted within that TWT window/SP. Thus, a periodic gap or underlying frequencies, or both, associated with TWT operation may vary with roundtrip time or streaming latency (for a given cadence of data generation or packet transmission).

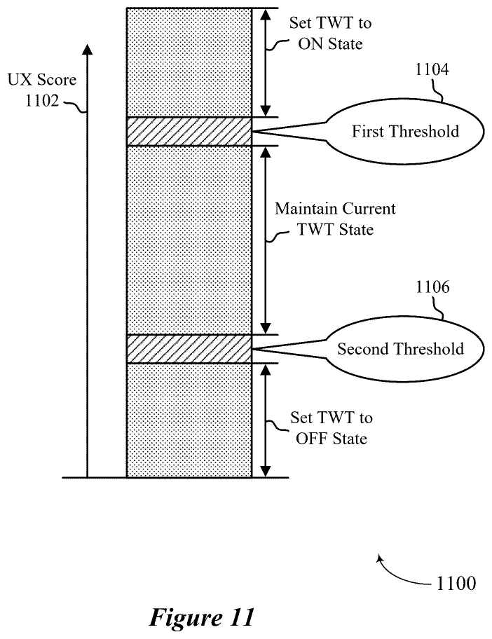

FIG. 11 shows an example UX scoring scheme 1100 that supports TWT session adaptation. The UX scoring scheme 1100 may implement or be implemented to realize one or more aspects of the wireless communication network 100, the wireless communication network 200, the system diagram 300, the processing timeline 400, the process flow 500, and the process flow 600. For example, the wireless device 302 or the wireless device 304, or both, may employ, use, or utilize the UX scoring scheme 1100 to support switching TWT ON or OFF dynamically.

In some networks, keeping TWT set to an ON state in relatively poor network conditions may cause or incur a negative impact on UX (without a satisfactory corresponding gain in device power savings). In such scenarios of relatively poor network conditions, the wireless device 302 or the wireless device 304 may turn OFF TWT to achieve or facilitate a greater UX and higher performance. In some implementations, the wireless device 302 or the wireless device 304 may calculate a UX score 1102 and may set a state associated with a usage of TWT sessions to an ON state or an OFF state based on the UX score 1102. In other words, the wireless device 302 or the wireless device 304 may set a state associated with TWT operation to an ON state or an OFF state based on the UX score 1102.

The wireless device 302 or the wireless device 304 may determine or calculate the UX score 1102 based on one or more parameters or metrics, such as an M2R2P latency metric, one or more network condition metrics, one or more system parameters, or any combination thereof. Such system parameters may include one or more of a CPU resource utilization, a GPU resource utilization, an NPU resource utilization, a device power metric, and a device thermal metric, among other examples. The wireless device 302 or the wireless device 304 may compare the UX score 1102 to one or more thresholds to determine whether to set the usage of TWT sessions to the ON state or the OFF state.

In some implementations, for example, the wireless device 302 or the wireless device 304 may compare the UX score 1102 to a first threshold 1104 and a second threshold 1106 (such as an upper threshold and a lower threshold). In such implementations, the first threshold 1104 may correspond to a score value above which the wireless device 302 or the wireless device 304 may set the usage of TWT sessions to the ON state and the second threshold 1106 may correspond to a score value below which the wireless device 302 or the wireless device 304 may set the usage of TWT sessions to the OFF state. In other words, the first threshold 1104 may be a UX score value above which a UX is acceptable and the second threshold 1106 may be a UX score value below which the UX is undesirable or unacceptable. In some other implementations, the wireless device 302 or the wireless device 304 may compare the UX score 1102 to a single threshold. In such implementations, the wireless device 302 or the wireless device 304 may set the usage of TWT sessions to the ON state if the UX score 1102 is greater than (or equal to) the single threshold and may set the usage of TWT sessions to the OFF state if the UX score 1102 is less than (or equal to) the single threshold.

Additionally, or alternatively, for multiple TWT sessions (such as multiple TWT windows/SPs), if an SP sleep-to-wake latency and an SP wake-to-sleep latency is more than a TWT “OFF” period, the wireless device 302 or the wireless device 304 may set the usage of TWT sessions to the OFF state. For example, in such scenarios, the wireless device 302 or the wireless device 304 may effectively be in a Wi-Fi “ON” time all or most of the time (such as greater than a threshold amount of time) regardless of use of TWT, such that leaving usage of TWT sessions in the ON state may achieve relatively little (if any) device power savings (such that TWT operation may cause device complexity without a satisfactory corresponding increase in device power savings).

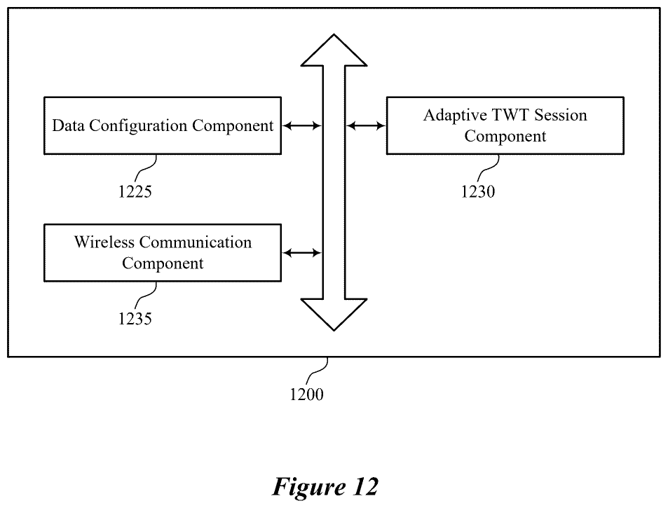

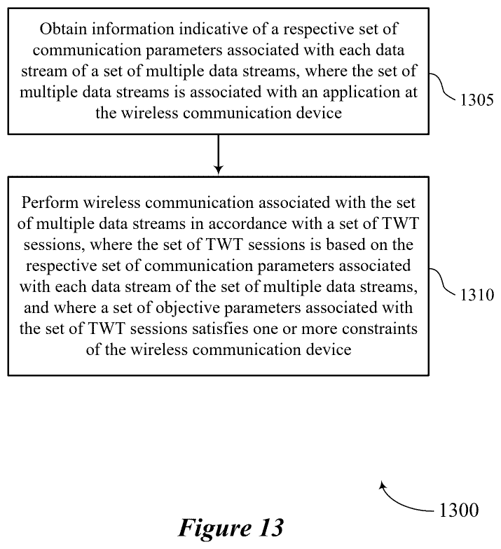

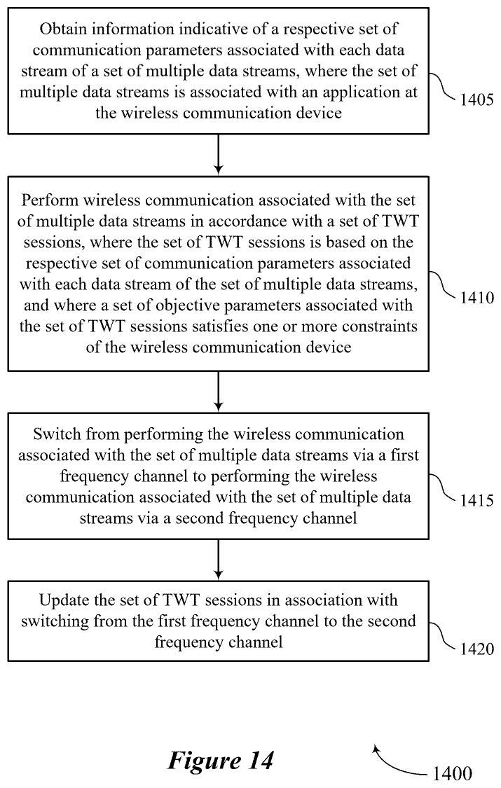

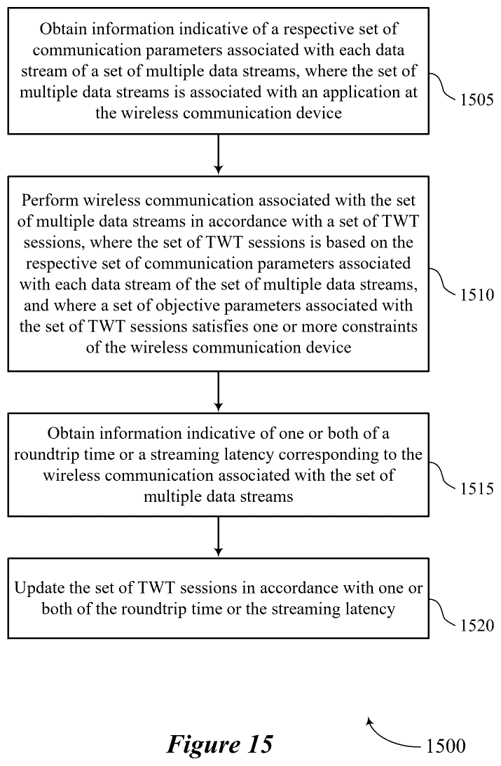

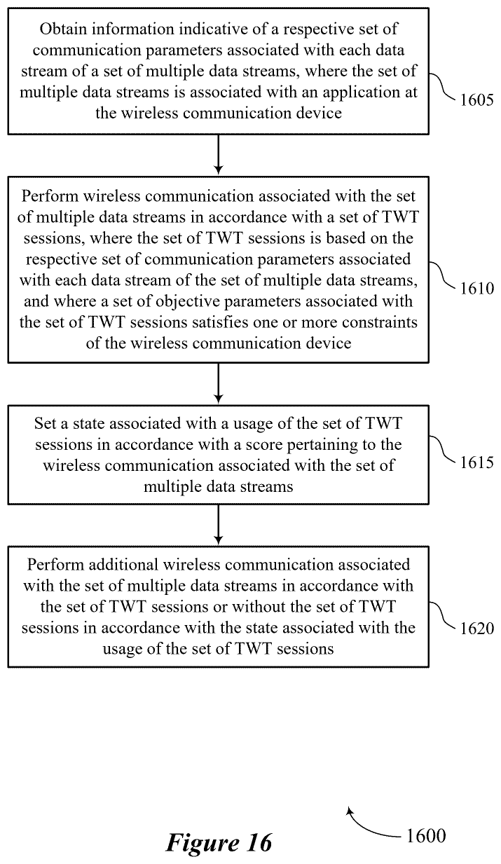

FIG. 12 shows a block diagram of an example wireless communication device 1200 that supports TWT session adaptation. In some examples, the wireless communication device 1200 is configured to perform the processes 1300, 1400, 1500, and 1600 described with reference to FIGS. 13, 14, 15, and 16, respectively. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as CPUs, GPUs, NPUs (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP or STA, such as the AP 102 or the STA 104 described with reference to FIG. 1. In some other examples, the wireless communication device 1200 can be an AP or STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a data configuration component 1225, an adaptive TWT session component 1230, and a wireless communication component 1235. Portions of one or more of the data configuration component 1225, the adaptive TWT session component 1230, and the wireless communication component 1235 may be implemented at least in part in hardware or firmware. For example, one or more of the data configuration component 1225, the adaptive TWT session component 1230, and the wireless communication component 1235 may be implemented at least in part by at least a processor or a modem. In some examples, portions of one or more of the data configuration component 1225, the adaptive TWT session component 1230, and the wireless communication component 1235 may be implemented at least in part by a processor and software in the form of processor-executable code stored in memory.

The wireless communication device 1200 may support wireless communications in accordance with examples as disclosed herein. The data configuration component 1225 is configurable or configured to obtain information indicative of a respective set of communication parameters associated with each data stream of a set of multiple data streams, where the set of multiple data streams is associated with an application at the wireless communication device. The adaptive TWT session component 1230 is configurable or configured to determine, create, open, assign, generate, schedule, or communicate information indicative of a set of TWT sessions associated with the set of multiple data streams, where the set of TWT sessions is based on the respective set of communication parameters associated with each data stream of the set of multiple data streams, and where a set of objective parameters associated with the set of TWT sessions satisfies one or more constraints of the wireless communication device. The wireless communication component 1235 is configurable or configured to perform wireless communication (such as transmit or receive one or more data packets, PPDUs, or frames) associated with the set of multiple data streams in accordance with the set of TWT sessions.

In some examples, the wireless communication component 1235 is configurable or configured to switch from performing the wireless communication associated with the set of multiple data streams via a first frequency channel to performing the wireless communication associated with the set of multiple data streams via a second frequency channel. In some examples, the adaptive TWT session component 1230 is configurable or configured to update the set of TWT sessions in association with switching from the first frequency channel to the second frequency channel.

In some examples, to support updating the set of TWT sessions, the adaptive TWT session component 1230 is configurable or configured to increase one or more TWT window durations associated with the set of TWT sessions in accordance with the second frequency channel being a lower frequency channel than the first frequency channel. In some examples, to support updating the set of TWT sessions, the adaptive TWT session component 1230 is configurable or configured to decrease the one or more TWT window durations associated with the set of TWT sessions in accordance with the second frequency channel being a higher frequency channel than the first frequency channel.

In some examples, the wireless communication component 1235 is configurable or configured to obtain information indicative of one or both of a roundtrip time or a streaming latency corresponding to the wireless communication associated with the set of multiple data streams. In some examples, the adaptive TWT session component 1230 is configurable or configured to update the set of TWT sessions in accordance with one or both of the roundtrip time or the streaming latency.

In some examples, the adaptive TWT session component 1230 is configurable or configured to determine a score pertaining to the wireless communication associated with the set of multiple data streams. In some examples, the adaptive TWT session component 1230 is configurable or configured to set a state associated with a usage of the set of TWT sessions in accordance with the score. In some examples, the wireless communication component 1235 is configurable or configured to perform additional wireless communication associated with the set of multiple data streams in accordance with the set of TWT sessions or without the set of TWT sessions in accordance with the state associated with the usage of the set of TWT sessions.

In some examples, to support setting the state associated with the usage of the set of TWT sessions, the adaptive TWT session component 1230 is configurable or configured to set the set of TWT sessions to an OFF state in accordance with the score failing to satisfy a first threshold score. In some examples, to support setting the state associated with the usage of the set of TWT sessions, the adaptive TWT session component 1230 is configurable or configured to set the set of TWT sessions to an ON state in accordance with the score satisfying a second threshold score.

In some examples, the score is a user experience score pertaining to the wireless communication associated with the set of multiple data streams. In some examples, the user experience score is based on (determined in accordance with) one or more of a network condition; an M2R2P latency at the wireless communication device; a CPU resource utilization at the wireless communication device; a GPU resource utilization at the wireless communication device; a power metric of the wireless communication device; and a thermal metric of the wireless communication device.

In some examples, to support determining the set of TWT sessions, the adaptive TWT session component 1230 is configurable or configured to assign (such as determine or preliminarily create) a respective independent TWT session for each data stream of the set of multiple data streams based on the respective set of communication parameters associated with that data stream of the set of multiple data streams. In some examples, to support determining the set of TWT sessions, the adaptive TWT session component 1230 is configurable or configured to determine, for each data stream of the set of multiple data streams and based on the respective set of communication parameters associated with that data stream and the set of objective parameters, whether to create the respective independent TWT session for that data stream or to merge the respective independent TWT session for that data stream with one or more other TWT sessions for one or more other data streams of the set of multiple data streams. In other words, for each data stream of the set of multiple data streams and based on the respective set of communication parameters associated with that data stream and the set of objective parameters, the adaptive TWT session component 1230 is configurable or configured to create the respective independent TWT session for that data stream or to merge the respective independent TWT session for that data stream with one or more other TWT sessions for one or more other data streams of the set of multiple data streams.

In some examples, to support determining the set of TWT sessions, the adaptive TWT session component 1230 is configurable or configured to create (such as open or determine, for example, as a “finalized” TWT session at 610 of the process flow 600) a first independent TWT session for a first data stream of the set of multiple data streams in accordance with a first set of communication parameters associated with the first data stream and a first set of objective parameters associated with the first independent TWT session.

In some examples, the first independent TWT session is created for the first data stream in accordance with other TWT sessions failing to satisfy the first set of communication parameters and the first set of objective parameters associated with the first independent TWT session satisfying the one or more constraints of the wireless communication device.

In some examples, to support determining the set of TWT sessions, the adaptive TWT session component 1230 is configurable or configured to merge (such as open or determine, for example, as a “finalized” merged TWT session at 610 of the process flow 600) a first independent TWT session for a first data stream of the set of multiple data streams with a second independent TWT session for a second data stream of the set of multiple data streams in accordance with a first set of communication parameters associated with the first data stream and a first set of objective parameters associated with the first independent TWT session.

In some examples, the first independent TWT session for the first data stream is merged with the second independent TWT session for the second data stream in accordance with the second independent TWT session satisfying the first set of communication parameters, or the first set of objective parameters associated with the first independent TWT session failing to satisfy the one or more constraints of the wireless communication device.

In some examples, to support determining the set of TWT sessions, the adaptive TWT session component 1230 is configurable or configured to create a merged TWT session in association with determining to merge the first independent TWT session with the second independent TWT session, where a periodicity of the merged TWT session is a greater periodicity between a first periodicity associated with the first independent TWT session and a second periodicity associated with the second independent TWT session, or is an effective periodicity between the first periodicity associated with the first independent TWT session and the second periodicity associated with the second independent TWT session.

In some examples, to support determining the set of TWT sessions, the adaptive TWT session component 1230 is configurable or configured to create (such as open, schedule, or determine) an initial set of TWT sessions based on the respective set of communication parameters associated with each data stream of the set of multiple data streams and the set of objective parameters. In some examples, to support determining the set of TWT sessions, the adaptive TWT session component 1230 is configurable or configured to create (such as open, schedule, or determine) an updated set of TWT sessions in accordance with a respective set of updated communication parameters associated with each data stream of the set of multiple data streams or an updated set of objective parameters.

In some examples, the wireless communication component 1235 is configurable or configured to transmit an indication of the set of TWT sessions, where performing the wireless communication associated with the set of multiple data streams is in association with transmitting the indication of the set of TWT sessions. In some examples, each TWT session of the set of TWT sessions is associated with a respective TWT window duration and a respective periodicity.

In some examples, the respective set of communication parameters associated with each data stream of the set of multiple data streams includes one or more of a frequency associated with that data stream; a latency tolerance associated with that data stream; and a transmit or receive duration associated with that data stream. In some examples, the set of objective parameters includes one or more of a total effective SP associated with the set of TWT sessions; a power budget metric associated with the set of TWT sessions; latency tolerances associated with the set of multiple data streams; a UX score pertaining to the wireless communication associated with the set of multiple data streams in accordance with the set of TWT sessions; and a thermal metric of the wireless communication device associated with the set of TWT sessions.

FIG. 13 shows a flowchart illustrating an example process 1300 performable by or at a wireless communication device that supports TWT session adaptation. The operations of the process 1300 may be implemented by a wireless communication device or its components as described herein. For example, the process 1300 may be performed by a wireless communication device, such as the wireless communication device 1200 described with reference to FIG. 12, operating as or within a wireless AP or a wireless STA. In some examples, the process 1300 may be performed by a wireless AP or a wireless STA, such as one of the APs 102 or the STAs 104 described with reference to FIG. 1. In some examples, the process 1300 may be performed by the wireless device 302 or the wireless device 304 described with reference to FIG. 3.

In some examples, in 1305, the wireless communication device may obtain information indicative of a respective set of communication parameters associated with each data stream of a set of multiple data streams, where the set of multiple data streams is associated with an application at the wireless communication device. The operations of 1305 may be performed in accordance with examples as disclosed herein. For example, a set of communication parameters may be an example of a set of communication parameters 508 as illustrated by and described with reference to FIG. 5. Further, the set of multiple data streams may be the set of data streams 402 of FIG. 4, the set of data streams 702 of FIG. 7, or the set of data streams 802 of FIG. 8. In some implementations, aspects of the operations of 1305 may be performed by a data configuration component 1225 as described with reference to FIG. 12.

In some examples, in 1310, the wireless communication device may perform wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device. The operations of 1310 may be performed in accordance with examples as disclosed herein, such as the sets of communication parameters 508 and the set of objective parameters 518 of FIG. 5. Further, the set of TWT sessions may be or include TWT session(s) determined by the TWT session adapter 512 of FIG. 5, TWT session(s) determined at 616 of FIG. 6, the TWT session 716 and the TWT session 718 of FIG. 7, the TWT session 812 and the TWT session 814 of FIG. 8, the TWT session 902 of FIG. 9, or one or both of the initial TWT session 1002 and the adapted TWT session 1006 of FIG. 10. Further, the wireless communication device may perform wireless communication via one or multiple frequency channels 310, as illustrated by and described with reference to FIG. 3. In some implementations, aspects of the operations of 1310 may be performed by a wireless communication component 1235 as described with reference to FIG. 12.

FIG. 14 shows a flowchart illustrating an example process 1400 performable by or at a wireless communication device that supports TWT session adaptation. The operations of the process 1400 may be implemented by a wireless communication device or its components as described herein. For example, the process 1400 may be performed by a wireless communication device, such as the wireless communication device 1200 described with reference to FIG. 12, operating as or within a wireless AP or a wireless STA. In some examples, the process 1400 may be performed by a wireless AP or a wireless STA, such as one of the APs 102 or the STAs 104 described with reference to FIG. 1. In some examples, the process 1400 may be performed by the wireless device 302 or the wireless device 304 described with reference to FIG. 3.

In some examples, in 1405, the wireless communication device may obtain information indicative of a respective set of communication parameters associated with each data stream of a set of multiple data streams, where the set of multiple data streams is associated with an application at the wireless communication device. The operations of 1405 may be performed in accordance with examples as disclosed herein. For example, a set of communication parameters may be an example of a set of communication parameters 508 as illustrated by and described with reference to FIG. 5. Further, the set of multiple data streams may be the set of data streams 402 of FIG. 4, the set of data streams 702 of FIG. 7, or the set of data streams 802 of FIG. 8. In some implementations, aspects of the operations of 1405 may be performed by a data configuration component 1225 as described with reference to FIG. 12.

In some examples, in 1410, the wireless communication device may perform wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device. The operations of 1410 may be performed in accordance with examples as disclosed herein, such as the sets of communication parameters 508 and the set of objective parameters 518 of FIG. 5. Further, the set of TWT sessions may be or include TWT session(s) determined by the TWT session adapter 512 of FIG. 5, TWT session(s) determined at 616 of FIG. 6, the TWT session 716 and the TWT session 718 of FIG. 7, the TWT session 812 and the TWT session 814 of FIG. 8, the TWT session 902 of FIG. 9, or one or both of the initial TWT session 1002 and the adapted TWT session 1006 of FIG. 10. Further, the wireless communication device may perform wireless communication via one or multiple frequency channels 310, as illustrated by and described with reference to FIG. 3. In some implementations, aspects of the operations of 1410 may be performed by a wireless communication component 1235 as described with reference to FIG. 12.

In some examples, in 1415, the wireless communication device may switch from performing the wireless communication associated with the set of multiple data streams via a first frequency channel to performing the wireless communication associated with the set of multiple data streams via a second frequency channel. The operations of 1415 may be performed in accordance with examples as disclosed herein, such as in accordance with the TWT session determination scheme 1000 of FIG. 10. In some implementations, aspects of the operations of 1415 may be performed by a wireless communication component 1235 as described with reference to FIG. 12.

In some examples, in 1420, the wireless communication device may update the set of TWT sessions in association with switching from the first frequency channel to the second frequency channel. The operations of 1420 may be performed in accordance with examples as disclosed herein, such as in accordance with the TWT session determination scheme 1000 of FIG. 10. In some implementations, aspects of the operations of 1420 may be performed by an adaptive TWT session component 1230 as described with reference to FIG. 12.

FIG. 15 shows a flowchart illustrating an example process 1500 performable by or at a wireless communication device that supports TWT session adaptation. The operations of the process 1500 may be implemented by a wireless communication device or its components as described herein. For example, the process 1500 may be performed by a wireless communication device, such as the wireless communication device 1200 described with reference to FIG. 12, operating as or within a wireless AP or a wireless STA. In some examples, the process 1500 may be performed by a wireless AP or a wireless STA, such as one of the APs 102 or the STAs 104 described with reference to FIG. 1. In some examples, the process 1500 may be performed by the wireless device 302 or the wireless device 304 described with reference to FIG. 3.

In some examples, in 1505, the wireless communication device may obtain information indicative of a respective set of communication parameters associated with each data stream of a set of multiple data streams, where the set of multiple data streams is associated with an application at the wireless communication device. The operations of 1505 may be performed in accordance with examples as disclosed herein. For example, a set of communication parameters may be an example of a set of communication parameters 508 as illustrated by and described with reference to FIG. 5. Further, the set of multiple data streams may be the set of data streams 402 of FIG. 4, the set of data streams 702 of FIG. 7, or the set of data streams 802 of FIG. 8. In some implementations, aspects of the operations of 1505 may be performed by a data configuration component 1225 as described with reference to FIG. 12.

In some examples, in 1510, the wireless communication device may perform wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device. The operations of 1510 may be performed in accordance with examples as disclosed herein, such as the sets of communication parameters 508 and the set of objective parameters 518 of FIG. 5. Further, the set of TWT sessions may be or include TWT session(s) determined by the TWT session adapter 512 of FIG. 5, TWT session(s) determined at 616 of FIG. 6, the TWT session 716 and the TWT session 718 of FIG. 7, the TWT session 812 and the TWT session 814 of FIG. 8, the TWT session 902 of FIG. 9, or one or both of the initial TWT session 1002 and the adapted TWT session 1006 of FIG. 10. Further, the wireless communication device may perform wireless communication via one or multiple frequency channels 310, as illustrated by and described with reference to FIG. 3. In some implementations, aspects of the operations of 1510 may be performed by a wireless communication component 1235 as described with reference to FIG. 12.

In some examples, in 1515, the wireless communication device may obtain information indicative of one or both of a roundtrip time or a streaming latency corresponding to the wireless communication associated with the set of multiple data streams. The operations of 1515 may be performed in accordance with examples as disclosed herein, such as in accordance with the TWT session determination scheme 1000 of FIG. 10. In some implementations, aspects of the operations of 1515 may be performed by a wireless communication component 1235 as described with reference to FIG. 12.

In some examples, in 1520, the wireless communication device may update the set of TWT sessions in accordance with one or both of the roundtrip time or the streaming latency. The operations of 1520 may be performed in accordance with examples as disclosed herein, such as in accordance with the TWT session determination scheme 1000 of FIG. 10. In some implementations, aspects of the operations of 1520 may be performed by an adaptive TWT session component 1230 as described with reference to FIG. 12.

FIG. 16 shows a flowchart illustrating an example process 1600 performable by or at a wireless communication device that supports TWT session adaptation. The operations of the process 1600 may be implemented by a wireless communication device or its components as described herein. For example, the process 1600 may be performed by a wireless communication device, such as the wireless communication device 1200 described with reference to FIG. 12, operating as or within a wireless AP or a wireless STA. In some examples, the process 1600 may be performed by a wireless AP or a wireless STA, such as one of the APs 102 or the STAs 104 described with reference to FIG. 1. In some examples, the process 1600 may be performed by the wireless device 302 or the wireless device 304 described with reference to FIG. 3.

In some examples, in 1605, the wireless communication device may obtain information indicative of a respective set of communication parameters associated with each data stream of a set of multiple data streams, where the set of multiple data streams is associated with an application at the wireless communication device. The operations of 1605 may be performed in accordance with examples as disclosed herein. For example, a set of communication parameters may be an example of a set of communication parameters 508 as illustrated by and described with reference to FIG. 5. Further, the set of multiple data streams may be the set of data streams 402 of FIG. 4, the set of data streams 702 of FIG. 7, or the set of data streams 802 of FIG. 8. In some implementations, aspects of the operations of 1605 may be performed by a data configuration component 1225 as described with reference to FIG. 12.

In some examples, in 1610, the wireless communication device may perform wireless communication associated with the set of multiple data streams in accordance with a set of TWT sessions, where the set of TWT sessions is based on the respective set of communication parameters associated with each data stream of the set of multiple data streams, and where a set of objective parameters associated with the set of TWT sessions satisfies one or more constraints of the wireless communication device. The operations of 1610 may be performed in accordance with examples as disclosed herein, such as the sets of communication parameters 508 and the set of objective parameters 518 of FIG. 5. Further, the set of TWT sessions may be or include TWT session(s) determined by the TWT session adapter 512 of FIG. 5, TWT session(s) determined at 616 of FIG. 6, the TWT session 716 and the TWT session 718 of FIG. 7, the TWT session 812 and the TWT session 814 of FIG. 8, the TWT session 902 of FIG. 9, or one or both of the initial TWT session 1002 and the adapted TWT session 1006 of FIG. 10. Further, the wireless communication device may perform wireless communication via one or multiple frequency channels 310, as illustrated by and described with reference to FIG. 3. In some implementations, aspects of the operations of 1610 may be performed by a wireless communication component 1235 as described with reference to FIG. 12.

In some examples, in 1615, the wireless communication device may set a state associated with a usage of the set of TWT sessions in accordance with a score pertaining to the wireless communication associated with the set of multiple data streams. The operations of 1615 may be performed in accordance with examples as disclosed herein, such as in accordance with determining a UX score 1102 based on the UX scoring scheme 1100. Further, the operations of 1615 may be performed in accordance with examples as disclosed herein, such as in accordance with determining whether the UX score 1102 satisfies the first threshold 1104 or the second threshold 1106 as illustrated by and described with reference to FIG. 11, among other examples. In some implementations, aspects of the operations of 1615 may be performed by an adaptive TWT session component 1230 as described with reference to FIG. 12.

In some examples, in 1620, the wireless communication device may perform additional wireless communication associated with the set of multiple data streams in accordance with the set of TWT sessions or without the set of TWT sessions in accordance with the state associated with the usage of the set of TWT sessions. The operations of 1620 may be performed in accordance with examples as disclosed herein. For example, the wireless communication device may perform wireless communication via one or multiple frequency channels 310, as illustrated by and described with reference to FIG. 3. In some implementations, aspects of the operations of 1620 may be performed by a wireless communication component 1235 as described with reference to FIG. 12.

Implementation examples are described in the following numbered clauses:

Clause 1: A method for wireless communications by or at a wireless communication device, including: obtaining information indicative of a respective set of communication parameters associated with each data stream of a plurality of data streams, where the plurality of data streams is associated with an application at the wireless communication device; and performing wireless communication associated with the plurality of data streams in accordance with a set of TWT sessions, where the set of TWT sessions is based at least in part on the respective set of communication parameters associated with each data stream of the plurality of data streams, and where a set of objective parameters associated with the set of TWT sessions satisfies one or more constraints of the wireless communication device.

Clause 2: The method of clause 1, further including: switching from performing the wireless communication associated with the plurality of data streams via a first frequency channel to performing the wireless communication associated with the plurality of data streams via a second frequency channel; and updating the set of TWT sessions in association with switching from the first frequency channel to the second frequency channel.

Clause 3: The method of clause 2, where updating the set of TWT sessions includes: increasing one or more TWT window durations associated with the set of TWT sessions in accordance with the second frequency channel being a lower frequency channel than the first frequency channel; or decreasing the one or more TWT window durations associated with the set of TWT sessions in accordance with the second frequency channel being a higher frequency channel than the first frequency channel.

Clause 4: The method of any of clauses 1-3, further including: obtaining information indicative of one or both of a roundtrip time or a streaming latency corresponding to the wireless communication associated with the plurality of data streams; and updating the set of TWT sessions in accordance with one or both of the roundtrip time or the streaming latency.

Clause 5: The method of any of clauses 1-4, further including: setting a state associated with a usage of the set of TWT sessions in accordance with a score pertaining to the wireless communication associated with the plurality of data streams; and performing additional wireless communication associated with the plurality of data streams in accordance with the set of TWT sessions or without the set of TWT sessions in accordance with the state associated with the usage of the set of TWT sessions.

Clause 6: The method of clause 5, where setting the state associated with the usage of the set of TWT sessions includes: setting the set of TWT sessions to an OFF state in accordance with the score failing to satisfy a first threshold score; or setting the set of TWT sessions to an ON state in accordance with the score satisfying a second threshold score.

Clause 7: The method of any of clauses 5-6, where the score is a UX score pertaining to the wireless communication associated with the plurality of data streams, and the UX score is based at least in part on one or more of a network condition; an M2R2P latency at the wireless communication device; a CPU resource utilization at the wireless communication device; a GPU resource utilization at the wireless communication device; a power metric of the wireless communication device; and a thermal metric of the wireless communication device.

Clause 8: The method of any of clauses 1-7, where assigning a respective independent TWT session for each data stream of the plurality of data streams in accordance with the respective set of communication parameters associated with that data stream of the plurality of data streams, where, for each data stream of the plurality of data streams and based at least in part on the respective set of communication parameters associated with that data stream and the set of objective parameters, the method further includes: creating the respective independent TWT session for that data stream; or merging the respective independent TWT session for that data stream with one or more other TWT sessions for one or more other data streams of the plurality of data streams.

Clause 9: The method of clause 8, further including: creating a first independent TWT session for a first data stream of the plurality of data streams in accordance with a first set of communication parameters associated with the first data stream and a first set of objective parameters associated with the first independent TWT session.

Clause 10: The method of clause 9, where the first independent TWT session is created for the first data stream in accordance with other TWT sessions failing to satisfy the first set of communication parameters and the first set of objective parameters associated with the first independent TWT session satisfying the one or more constraints of the wireless communication device.

Clause 11: The method of any of clauses 8-10, further including: merging a first independent TWT session for a first data stream of the plurality of data streams with a second independent TWT session for a second data stream of the plurality of data streams in accordance with a first set of communication parameters associated with the first data stream and a first set of objective parameters associated with the first independent TWT session.

Clause 12: The method of clause 11, where the first independent TWT session for the first data stream is merged with the second independent TWT session for the second data stream in accordance with the second independent TWT session satisfying the first set of communication parameters or the first set of objective parameters associated with the first independent TWT session failing to satisfy the one or more constraints of the wireless communication device.

Clause 13: The method of any of clauses 11-12, further including: creating a merged TWT session in association with merging the first independent TWT session with the second independent TWT session, where a periodicity of the merged TWT session is a greater periodicity between a first periodicity associated with the first independent TWT session and a second periodicity associated with the second independent TWT session, or is an effective periodicity between the first periodicity associated with the first independent TWT session and the second periodicity associated with the second independent TWT session.

Clause 14: The method of any of clauses 1-13, further including: creating an initial set of TWT sessions in accordance with the respective set of communication parameters associated with each data stream of the plurality of data streams and the set of objective parameters; and creating an updated set of TWT sessions in accordance with a respective set of updated communication parameters associated with each data stream of the plurality of data streams or an updated set of objective parameters.

Clause 15: The method of any of clauses 1-14, further including: transmitting an indication of the set of TWT sessions, where performing the wireless communication associated with the plurality of data streams is in association with transmitting the indication of the set of TWT sessions.

Clause 16: The method of any of clauses 1-15, where each TWT session of the set of TWT sessions is associated with a respective TWT window duration and a respective periodicity.

Clause 17: The method of any of clauses 1-16, where the respective set of communication parameters associated with each data stream of the plurality of data streams includes one or more of a frequency associated with that data stream; a latency tolerance associated with that data stream; and a transmit or receive duration associated with that data stream.

Clause 18: The method of any of clauses 1-17, where the set of objective parameters includes one or more of a total effective SP associated with the set of TWT sessions; a power budget metric associated with the set of TWT sessions; latency tolerances associated with the plurality of data streams; a UX score pertaining to the wireless communication associated with the plurality of data streams in accordance with the set of TWT sessions; and a thermal metric of the wireless communication device associated with the set of TWT sessions.

Clause 19: A wireless communication device, including a processing system that includes processor circuitry and memory circuitry that stores code, the processing system configured to cause the wireless communication device to perform a method of any of clauses 1-18.

Clause 20: A wireless communication device, including one or more memories storing processor-executable code, and one or more processors coupled with the one or more memories and individually or collectively operable to execute the code to cause the wireless communication device to perform a method of any of clauses 1-18.

Clause 21: A wireless communication device, including at least one means for performing a method of any of clauses 1-18.

Clause 22: A non-transitory computer-readable medium storing code for wireless communications, the code including instructions executable by one or more processors (such as or via a processing system) to perform a method of any of clauses 1-18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset”refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a”and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes processor circuitry and memory circuitry that stores code, the processing system configured to cause the wireless communication device to:
obtain information indicative of a respective set of communication parameters associated with each data stream of a plurality of data streams, wherein the plurality of data streams is associated with an application at the wireless communication device; and
perform wireless communication associated with the plurality of data streams in accordance with a set of target wake time sessions, wherein the set of target wake time sessions is based at least in part on the respective set of communication parameters associated with each data stream of the plurality of data streams, and wherein a set of objective parameters associated with the set of target wake time sessions satisfies one or more constraints of the wireless communication device.

2. The wireless communication device of claim 1, wherein the processing system is further configured to cause the wireless communication device to:
switch from performing the wireless communication associated with the plurality of data streams via a first frequency channel to performing the wireless communication associated with the plurality of data streams via a second frequency channel; and
update the set of target wake time sessions in association with switching from the first frequency channel to the second frequency channel.

3. The wireless communication device of claim 2, wherein, to update the set of target wake time sessions, the processing system is configured to cause the wireless communication device to:
increase one or more target wake time window durations associated with the set of target wake time sessions in accordance with the second frequency channel being a lower frequency channel than the first frequency channel; or
decrease the one or more target wake time window durations associated with the set of target wake time sessions in accordance with the second frequency channel being a higher frequency channel than the first frequency channel.

4. The wireless communication device of claim 1, wherein the processing system is further configured to cause the wireless communication device to:
obtain information indicative of one or both of a roundtrip time or a streaming latency corresponding to the wireless communication associated with the plurality of data streams; and
update the set of target wake time sessions in accordance with one or both of the roundtrip time or the streaming latency.

5. The wireless communication device of claim 1, wherein the processing system is further configured to cause the wireless communication device to:
set a state associated with a usage of the set of target wake time sessions in accordance with a score pertaining to the wireless communication associated with the plurality of data streams; and
perform additional wireless communication associated with the plurality of data streams in accordance with the set of target wake time sessions or without the set of target wake time sessions in accordance with the state associated with the usage of the set of target wake time sessions.

6. The wireless communication device of claim 5, wherein, to set the state associated with the usage of the set of target wake time sessions, the processing system is configured to cause the wireless communication device to:
set the set of target wake time sessions to an OFF state in accordance with the score failing to satisfy a first threshold score; or
set the set of target wake time sessions to an ON state in accordance with the score satisfying a second threshold score.

7. The wireless communication device of claim 5, wherein:
the score is a user experience score pertaining to the wireless communication associated with the plurality of data streams, and
the user experience score is based at least in part on one or more of:
a network condition;
a motion-to-render-to-photon (M2R2P) latency at the wireless communication device;
a central processing unit (CPU) resource utilization at the wireless communication device;
a graphics processing unit (GPU) resource utilization at the wireless communication device;
a power metric of the wireless communication device; and
a thermal metric of the wireless communication device.

8. The wireless communication device of claim 1, wherein the processing system is configured to cause the wireless communication device to:
assign a respective independent target wake time session to each data stream of the plurality of data streams based at least in part on the respective set of communication parameters associated with that data stream of the plurality of data streams, and
wherein, for each data stream of the plurality of data streams and based at least in part on the respective set of communication parameters associated with that data stream and the set of objective parameters, the processing system is configured to cause the wireless communication device to:
create the respective independent target wake time session for that data stream, or
merge the respective independent target wake time session for that data stream with one or more other target wake time sessions for one or more other data streams of the plurality of data streams.

9. The wireless communication device of claim 8, wherein the processing system is further configured to cause the wireless communication device to:
create a first independent target wake time session for a first data stream of the plurality of data streams in accordance with a first set of communication parameters associated with the first data stream and a first set of objective parameters associated with the first independent target wake time session.

10. The wireless communication device of claim 9, wherein the first independent target wake time session is created for the first data stream in accordance with:
other target wake time sessions failing to satisfy the first set of communication parameters; and
the first set of objective parameters associated with the first independent target wake time session satisfying the one or more constraints of the wireless communication device.

11. The wireless communication device of claim 8, wherein the processing system is further configured to cause the wireless communication device to:
merge a first independent target wake time session for a first data stream of the plurality of data streams with a second independent target wake time session for a second data stream of the plurality of data streams in accordance with a first set of communication parameters associated with the first data stream and a first set of objective parameters associated with the first independent target wake time session.

12. The wireless communication device of claim 11, wherein the first independent target wake time session for the first data stream is merged with the second independent target wake time session for the second data stream in accordance with:
the second independent target wake time session satisfying the first set of communication parameters; or
the first set of objective parameters associated with the first independent target wake time session failing to satisfy the one or more constraints of the wireless communication device.

13. The wireless communication device of claim 11, wherein the processing system is further configured to cause the wireless communication device to:
create a merged target wake time session in association with merging the first independent target wake time session with the second independent target wake time session, wherein a periodicity of the merged target wake time session is:
a greater periodicity between a first periodicity associated with the first independent target wake time session and a second periodicity associated with the second independent target wake time session, or
is an effective periodicity between the first periodicity associated with the first independent target wake time session and the second periodicity associated with the second independent target wake time session.

14. The wireless communication device of claim 1, wherein the processing system is configured to cause the wireless communication device to:
create an initial set of target wake time sessions based at least in part on the respective set of communication parameters associated with each data stream of the plurality of data streams and the set of objective parameters; and
create an updated set of target wake time sessions in accordance with a respective set of updated communication parameters associated with each data stream of the plurality of data streams or an updated set of objective parameters.

15. The wireless communication device of claim 1, wherein the processing system is further configured to cause the wireless communication device to:
transmit an indication of the set of target wake time sessions, wherein performing the wireless communication associated with the plurality of data streams is in association with transmitting the indication of the set of target wake time sessions.

16. A method for wireless communications by a wireless communication device, comprising:
obtaining information indicative of a respective set of communication parameters associated with each data stream of a plurality of data streams, wherein the plurality of data streams is associated with an application at the wireless communication device; and
performing wireless communication associated with the plurality of data streams in accordance with a set of target wake time sessions, wherein the set of target wake time sessions is based at least in part on the respective set of communication parameters associated with each data stream of the plurality of data streams, and wherein a set of objective parameters associated with the set of target wake time sessions satisfies one or more constraints of the wireless communication device.

17. The method of claim 16, further comprising:
switching from performing the wireless communication associated with the plurality of data streams via a first frequency channel to performing the wireless communication associated with the plurality of data streams via a second frequency channel; and
updating the set of target wake time sessions in association with switching from the first frequency channel to the second frequency channel.

18. The method of claim 16, further comprising:
obtaining information indicative of one or both of a roundtrip time or a streaming latency corresponding to the wireless communication associated with the plurality of data streams; and
updating the set of target wake time sessions in accordance with one or both of the roundtrip time or the streaming latency.

19. The method of claim 16, further comprising:
setting a state associated with a usage of the set of target wake time sessions in accordance with a score pertaining to the wireless communication associated with the plurality of data streams; and
performing additional wireless communication associated with the plurality of data streams in accordance with the set of target wake time sessions or without the set of target wake time sessions in accordance with the state associated with the usage of the set of target wake time sessions.

20. A wireless communication device for wireless communications, comprising:
means for obtaining information indicative of a respective set of communication parameters associated with each data stream of a plurality of data streams, wherein the plurality of data streams is associated with an application at the wireless communication device; and
means for performing wireless communication associated with the plurality of data streams in accordance with a set of target wake time sessions, wherein the set of target wake time sessions is based at least in part on the respective set of communication parameters associated with each data stream of the plurality of data streams, and wherein a set of objective parameters associated with the set of target wake time sessions satisfies one or more constraints of the wireless communication device.
